(19) United States
(12) Patent Application Publication
(10) Pub. No.: US 2007/0181024 A1
(43) Pub. Date: Aug. 9, 2007

(54) Plate making apparatus and regenerative printing plate management method as well as interstage sleeve

(75) Inventors: Mitsuru Tabuchi, Hiroshima (JP); Hideaki Sakurai, Hiroshima (JP); Masahiro Matsubara, Hiroshima (JP); Shoichi Furukawa, Mihara (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MITSUBISHI HEAVY INDUSTRIES, Tokyo (JP)

(21) Appl. No.: 10/565,671

(22) PCT Filed: Apr. 28, 2004
(86) PCT No.: PCT/JP04/06171

§ 371 Date: Feb. 1, 2007

(51) Int. Cl. B41C 3/08

(52) U.S. Cl. 101/401.1

(57) ABSTRACT

The invention relates to a print making apparatus and provides a technique which makes it possible to achieve a generally high processing speed without depending upon enhancement of the processing speed of individual processing apparatus. A number of stations (S1 to S4) at least equal to the number of steps of a plate making procedure are arranged in order, and a plurality of processing apparatus (30 to 34) corresponding one by one to the steps of the plate making procedure are disposed in order of the plate making procedure at the stations (S1 to S4). A transport apparatus (11) successively transports a plurality of printing plates (1) from one to another one of the stations in order of the plate making procedure.

### TECHNICAL FIELD

This invention relates to a structure of a plate making apparatus, particularly a plate making apparatus suitable for use for plate making (regeneration) of a regenerative printing plate which is used repeatedly, a management method for a regenerative printing plate, and an interstage sleeve suitable for use with such a regenerative printing plate as just mentioned and so forth.

### BACKGROUND ART

In recent years, a regenerative printing plate whose pattern can be rewritten and which can be used repeatedly over and over again has been developed.

A rewriting process of a pattern of a regenerative printing plate is performed by a plate making apparatus (plate regeneration apparatus) for exclusive use. Particularly, a plate making apparatus provided on a printing machine is called on-machine plate making apparatus and allows rewriting of a pattern in a state wherein a printing plate is mounted on a printing cylinder. However, according to this form, printing cannot be performed during rewriting of the pattern, and a printing plate for exchange cannot be stocked in advance. Therefore, wasteful time appears and the production efficiency drops.

Therefore, a so-called extra-machine plate making apparatus which is a plate making apparatus provided independently of a printing machine outside the printing machine is proposed in these days [refer to, for example, Japanese Patent Laid-Open No. 2002-178481 (hereinafter referred to as Patent Document 1) or Japanese Patent Laid-Open No. 2001-199031 (hereinafter referred to as Patent Document 2)]. FIG. 30 is a schematic view showing a configuration of the plate making apparatus disclosed in Patent Document 1. In the printing making apparatus, a printing plate 116 is attached to a cylindrical support drum 101, and the support drum 101 is supported in a cantilever fashion by a bearing 103 of a pedestal 102 and driven by a motor. Further, on a transverse bar 113 provided in parallel to the bearing 103, processing apparatus for plate making (a picture portion forming apparatus 115, an erasing apparatus 121, a fixing apparatus 122, and an applying apparatus 123) are provided for sliding movement with respect to the transverse bar 113. The processing apparatus 115, 121, 122 and 123 perform processes for the printing plate 116 while they move horizontally along the rotating support drum 101. It is to be noted that, in the plate making apparatus disclosed in Patent Document 2, though not shown in FIG. 30, the support drum is supported at the opposite ends thereof by two bearings.

Further, since a regenerative printing plate is used repeatedly, in order to normally maintain a good printing quality, it is necessary to manage the use situations of the regenerative printing plate, that is, the number of prints, the type of printed matters, the number of times of regeneration and so forth. Japanese Patent Laid-Open No. 2001-322224 (hereinafter referred to as Patent Document 3) discloses a management method for a regenerative printing plate, and the method can be described briefly with reference to FIG. 31. In particular, as shown in FIG. 31, an identification number 131 is applied to a printing plate 130, and a file 132 corresponding to the identification number 131 is produced and registered into a database 133. On the file 132, columns for recording use situations of the printing plate 130 such as a schedule of use, an allocated job, a number of prints, a deterioration state and so forth are provided. Then, every time the printing plate 130 is used, the pertaining file 132 is read out based on the identification number 131 and the use situation is recorded for updating or deterioration is determined from the use situations. Patent Document 3 describes that, where the use situations of the printing plate 130 are managed in such a manner as described above, it is possible to uniformly discriminate the deterioration of the printing plate 130 and discriminate the available period of use appropriately.

Incidentally, the conventional plate making apparatus disclosed in Patent Document 1 roughly has the following two subjects. The first subject is that the processing speed (number of printing plates processed per hour) is low. In particular, in the conventional plate making apparatus, all of the processing apparatus 115, 121, 122 and 123 are disposed around the support drum 101 supported on the bearing 103 and the processing apparatus 115, 121, 122 and 123 successively perform their processes. Therefore, until after the processes of one printing plate 516 are completed, processing of a next printing plate cannot be performed. Accordingly, in order to raise the processing speed of the overall plate making apparatus, it is necessary to raise the individually processing speeds of the processing apparatus 115, 121, 122 and 123. However, there is a limit to this, and besides, the cost increases together with the enhancement of the processing speed. This is a subject which is common also to the plate making apparatus disclosed in Patent Document 2.

The second subject is that a large installation space is required. In particular, in the conventional plate making apparatus, since the support drum 101 is moved back and forth in an axial direction of the bearing 103 as shown in FIG. 32, a free space is required in a widthwise direction of the apparatus. Particularly where exchange of the printing plate 116 is performed mechanically, since it is necessary to install an auxiliary apparatus for drawing out the support drum 501 in a widthwise direction of the apparatus to exchange the printing plate 116, a space in the widthwise direction substantially more than twice the length in the axial direction of the support drum 101 is required. Therefore, where there is a restriction to the installation space, the back and forth movement of the support drum 101 is difficult and also it is difficult to automate the plate making. It is to be noted that, in the plate making apparatus disclosed in Patent Document 2, the support drum is extracted in an axial direction in a state whereon a bearing on one side is opened and the support drum is supported in a cantilever fashion by the bearing on the motor side. Also in this instance, a large space for exchanging the support drum in the widthwise direction of the apparatus is required similarly as in the case described hereinabove.

Also the conventional plate management method for a regenerative printing plate disclosed in Patent Document 3 has subjects. In particular, although Patent Document 3 does not include any particular description regarding the number application position of the identification number 131 to the printing plate 130, if a number is applied to the surface of the plate, then this restricts the printable area. Further, upon regeneration, the plate face is overwritten, and therefore, there is the possibility that reading of the identification number 131 may become impossible. On the other hand, if the number is applied to the rear surface of the plate, then every time the identification number is read, the printing plate 130 is removed from the supporting member (print drum, support drum described above or the like), which leads to damage to the fixing portion of the plate and hence restricts the number of times of regeneration. This similarly applies also where a number is applied to the opposite end portions of the printing plate 130, that is, portions of the printing plate 130 which are bent when the printing plate 130 is attached to the supporting member. It is to be noted that it is usually difficult and is not practical to read the identification number 131 applied to the rear surface of the plate from the front surface.

The present invention has been made taking such subjects as described above into consideration, and it is an object of the present invention to provide a plate making apparatus which makes it possible to achieve a generally high processing speed without depending upon enhancement of the processing speed of individual processing apparatus.

It is another object of the present invention to provide a print making apparatus which requires a reduced installation space and facilitates automation in exchange of a plate.

It is a further object of the present invention to provide a management method for a regenerative printing plate which assures a high degree of freedom in the application position of an identification number to facilitate management.

It is a still further object of the present invention to provide a management method for a regenerative printing plate which makes effective use of a function of a regenerative printing plate.

### DISCLOSURE OF THE INVENTION

In order to attain the objects described above, according to the present invention, a first plate making apparatus comprises a plurality of stations arranged in order, the number of the stations being at least equal to the number of steps of a plate making procedure, a plurality of processing apparatus corresponding one by one to the steps of the plate making procedure and disposed in order of the plate making procedure at the stations, and a transport apparatus for successively transporting a plurality of printing plates from one to another one of the stations in order of the plate making procedure. With the plate making apparatus, since parallel processing of a plurality of printing plates can be performed, even if the processing speeds of the individual processing apparatus are same as those in conventional apparatus, a high processing speed as a whole can be achieved.

It is to be noted that, although the present plate making apparatus may naturally be utilized for ordinary print making, where the printing plate is a regenerative printing plate, preferably a step of regenerating the plate face of the printing plate is included in the plate making procedure such that the plate making apparatus is formed as a plate regeneration apparatus and is utilized for regeneration of a regenerative printing plate. Where the present plate making apparatus is used as a plate regeneration apparatus, the processing speed required in rewriting of a pattern is enhanced, and operation with a reduced number of printing plates can be achieved. In this instance, at least a pattern erasing apparatus, a picture material applying apparatus, a drying apparatus and a pattern writing apparatus are provided as the processing apparatus.

As a handling method of the printing plate on the present plate making apparatus, although the printing plate may naturally be transported as it is in the form of a flat plate by the transport apparatus, preferably each of the printing plates is provided on an outerperiphery of a cylindrical carrier and is transported integrally with a carrier by the transport apparatus. Where a printing plate is integrated on the outer periphery of a carrier in this manner, handling of the printing plate is facilitated and also damage to the printing plate can be prevented. It is to be noted that, as a form of installation of the printing plate on the outer periphery of the carrier, not only a form of wrapping a printing plate in the form of a flat plate on the outer periphery of the carrier to secure the printing plate but also another form of fitting a cylindrical gapless printing plate having no seam thereon on the carrier and a further form of using the outer periphery itself of a carrier as a printing plate are included.

Preferably, the present plate making apparatus further comprise a carry-in apparatus including a before-processing stock section in which one or more such carriers before the plate making process are stocked, the carry-in section carrying in one of the carriers from the before-processing stock section to the transport apparatus. Where carriers can be stocked in the carry-in apparatus in this manner, incessant continuous carry-in of carriers can be achieved, and the processing capacity can be further enhanced.

As a configuration of the carry-in apparatus, preferably it is configured such that it includes, as the before-processing stock section, a pair of inclined rails for supporting the opposite ends of the carrier and further includes one or more stoppers provided on the inclined rails and capable of selecting either one of an on state in which rolling of the carrier is controlled and an off state in which rolling of the carrier is permitted, and carries in the carriers one by one by on/off changeover of the stoppers. With the plate making apparatus, stocking and carry-in of carriers can be achieved by a simple configuration. Further, since each of the carriers is supported at the opposite end portions thereof by the rails, damage to the printing plate provided on the outer periphery of the carrier can be prevented.

Preferably, the carry-in apparatus includes a decision apparatus for deciding a use situation of each printing plate before the printing plate is carried into the transport apparatus and a selection apparatus for taking out, where it is decided by the decision apparatus that the printing plate is not suitable for regeneration, the carrier which has the rejected printing plate thereon from the carry-in line. Where it is decided whether or not regeneration of the printing plate is appropriate to select a carrier in this manner before the carrier is carried in, wasteful processing does not occur, and the substantial processing capacity can be further enhanced.

The present plate making apparatus may further comprise a carry-out apparatus for carrying out the carriers after the plate making process from the transport apparatus, the carry-out apparatus including an after-processing stock section in which one or more such carried out carriers are stocked. Since carriers after the processing can be stocked, the necessity for an operator to stay at the carry-out apparatus is eliminated, and the operability is enhanced significantly.

As a configuration of the transport apparatus described above, preferably it is configured such that it includes at least a number of pairs of chuck apparatus on the opposite sides equal to the number of stations, and the chuck apparatus in pair grasp and transport the carrier. The chuck apparatus are configured such that they fit into openings at the opposite ends of each carrier to grasp the carrier from the opposite sides and center the carrier with a predetermined reference axis. Where a carrier is grasped from the opposite sides and handled by the chuck apparatus in this manner, the carrier can be carried in and out not in it axial direction (apparatus widthwise direction) but in a direction (direction of the front of the apparatus) perpendicular to the reference axis to and from the mounting and dismounting position by the chuck apparatus. Consequently, the space required for carry-in and carry-out of the carrier (plate exchange) can be reduced.

Preferably, the stations are arranged on a circle centered at a horizontal shaft. Further, the transport apparatus is configured such that it revolves the chuck apparatus around the horizontal shaft to carry the carriers in order from one to another one of the stations. Where the stations are arranged on the circle in this manner, the plate making apparatus can be formed in a compact structure wherein both of the height and the length are suppressed.

In this instance, carry-in and carry-out stations for mounting each carrier carried in from the outside on the chuck apparatus and dismounting the carrier after the plate making process therefor from the chuck apparatus to carry out the carrier to the out side may be provided at the lowest or highest location of the circle. Or, a carry-in station for mounting each carrier carried in from the out side on the chuck apparatus may be provided at the lowest or highest location of the circle, and a carry-out station for dismounting the carrier after the plate making process therefor from the chuck apparatus to carry out the carrier to the outside may be provided at a position opposing to the carry-in station at the lowest or highest location of the circle. According to such arrangement of the stations as described above, where an auxiliary apparatus for automating carry-in and carry-out of a carrier is provided, it can be installed readily.

Alternatively, the stations may be arranged on a line. In this instance, the transport apparatus is configured such that it causes the chuck apparatus to move back and forth along the line to successively carry the carriers from one to another one of the stations. Where the stations are arranged on the line in this manner, accessing from the lower side of the apparatus which is advantageous in liquid operation is permitted in many stations, and also contamination of the printing plate or the apparatus by drop of the liquid can be prevented.

In this instance, a carry-in station for mounting each carrier carried in from the outside on the chuck apparatus may be provided at one end of the line, and a carry-out station for dismounting the carrier after the plate making process therefor from the chuck apparatus to carry out the carrier to the outside may be provided at the other end of the line. Or, carry-in and carry-out stations for mounting each carrier carried in from the outside on the chuck apparatus and dismounting the carrier after the plate making process therefor from the chuck apparatus to carry out the carrier to the outside may be provided at one end of the line. According to such arrangement of the stations as described above, where an auxiliary apparatus for automating carry-in and carry-out of a carrier is provided, it can be installed readily.

It is to be noted that, where the stations are disposed on the circle centered at the horizontal shaft, the transport apparatus can be configured such that it includes a rotary member supported on the horizontal shaft and rotatable around the horizontal shaft, and the chuck apparatus is provided on the rotary member. Further, the transport apparatus maybe configured such that it includes a guide provided in an arrangement direction of the stations and a caterpillar member provided for circulation along the guide, and the chuck apparatus is provided on the caterpillar member. According to such configurations as just described, since the degree of freedom in layout of the processing apparatus is raised, they can be applied to both of a case wherein the stations are arranged on the circle centered at the horizontal shaft and another case wherein the stations are disposed on the line.

Further, the present plate making apparatus can be configured, separately from the configuration wherein a chuck apparatus is provided on the transport apparatus as described above, such that a pair of chuck apparatus are provided at each of the stations and the chuck apparatus mount and dismount each carrier to transfer the carrier between the station and the transport apparatus. Also in this instance, the chuck apparatus are configured for fitting into openings at the opposite ends of each carrier to grasp the carrier from the opposite sides and centering the carrier with a predetermined reference axis. Where each carrier is supported from the opposite sides thereof by the chuck apparatus at each of the stations in this manner, the carrier can be carried in and out not in the axial direction (apparatus widthwise direction) but in a direction perpendicular to the reference axis, that is, in the transport direction by the transport apparatus. Consequently, transfer of a carrier between the transport apparatus and each station is facilitated.

Where a carrier is used for handling of a printing plate as described above, preferably the plate making apparatus further comprise an adjustment apparatus for adjusting the position of each of the processing apparatus at each of the stations in response to the diameter of the carrier. Since the diameter of the carriers depends upon the print size and the cutoff of the printing plates, where the position of each of the processing apparatus is adjustable in this manner, the plate making apparatus can cope with carriers of various sizes.

Further preferably, any of the plate making apparatus described above further comprises a clean air supplying apparatus for supplying clean air to a periphery of each printing plate at least within a period of time after picture material is applied to the printing plate until the picture material is dried. With the plate making apparatus, adhering of foreign articles to the plate face can be prevented to prevent deterioration of the print quality.

Although the clean air supplied from the clean air supplying apparatus should have a cleanliness (cleanness) as high as possible, preferably the clean air has a cleanliness of class 1000 or more according to the FED standard.

It is to be noted that, in order that adhering of dust to the plate surface can be prevented without disturbing the coating film before it is dried, preferably the wind speed of the clean air colliding with the plate surface is within the range from 0.1 to 3 m/s. Further, in order that the clean air may be supplied over the overall region of the plate surface to which the picture material is applied, the area of a blast nozzle for clean air is preferably set so as to assure an area of 50% or more of the application region.

As a more preferred mode of the present plate making apparatus, it further comprises a chamber for isolating, from the outside, a space in which a series of processes in which at least picture material is applied to the surface of each printing plate by the applying apparatus and then the application film of the applied picture material is dried by the drying apparatus is performed, the clean air supplying apparatus supplying clean air into the inside of the chamber. Where the chamber is provided in this manner, invasion of dust from the external world is prevented. This eliminates the necessity for a fixed colliding wind speed and raises the degree of freedom in setting of the area of the blast nozzle for clean air. Further, also miniaturization of a blast source of the clean air supplying apparatus is possible, and a dust removing effect can be achieved also where an obstacle exists in the space surrounding the application face and a uniform flow speed cannot be obtained.

More preferably, the pressure in the chamber is set higher than that outside of the chamber. With the plate making apparatus, invasion of dust from the outside into the chamber can be prevented further effectively by a pressure difference between the inside and the outside of the chamber. In this instance, the pressure in the chamber is set higher by more than 1 Pa, preferably by more than 10 Pa, than that outside the chamber.

Preferably, the plate making apparatus further comprise an exhaust apparatus for compulsorily exhausting the air in the chamber to the outside. With the plate making apparatus, dust produced in the inside of the chamber can be eliminated to prevent adhering of dust to the plate surface with a higher degree of certainty. Further, in this instance, the plate making apparatus may further comprise a circulation system for circulating air exhausted by the exhaust apparatus to the clean air supplying apparatus so that the air after purified is used as clean air again. With the plate making apparatus, since exhaust air is not discharged to the outside of the chamber, no influence is had on the environment around the plate making apparatus.

While the blasting air volume of the clear air supplying apparatus may be fixed, preferably it is variably controlled. As a controlling method in this instance, the cleanliness in the chamber, preferably, in the proximity of the plate surface, is measured by means of a measuring instrument (for example, a particle sensor), and the air blasting air volume is controlled by feedback control so that the measurement value of the measuring instrument may be a predetermined value. With the plate making apparatus, even where dust is produced in the chamber or dust is admitted into the inside of the chamber from the outside when the chamber is opened and closed, the cleanliness in the chamber can be returned to the predetermined value rapidly.

Where the clean air supplying apparatus includes a filter used as means for purifying the air, the filter gradually suffers from clogging as the use thereof continues. Accordingly, even if the driving force of the blast source such as a fan is fixed, the air volume sometimes decreases due to the clogging of the filter. Therefore, preferably the plate making apparatus further comprises a measuring instrument for measuring the difference between the pressure in the chamber and the pressure outside of the chamber, and the driving force of the blast source of the clean air supplying apparatus is controlled by feedback control so that the measurement value of the measuring instrument may be a predetermined value. Or, the plate making apparatus further comprises a measuring instrument for measuring the wind speed of the clean air supplied from the clean air supplying apparatus, and the driving force of the blast source of the clean air supplying apparatus is controlled by feedback control so that the measurement value of the measuring instrument may be a predetermined value. With the plate making apparatus, even if clogging of the filter proceeds, the fixed air volume can be obtained.

Preferably, the present plate making apparatus further comprises a removing apparatus for removing foreign substance adhering to the surface of each printing plate before picture material is applied to the printing plate by the picture material applying apparatus. Where the plate surface is made clean in advance in this manner, a printing plate free from a defect can be made. It is to be noted, as the method of removing foreign substance, for example, a method of sucking foreign substance, a method of blowing off foreign substance, a method of causing foreign substance to adhere to an adhesive member, a method of wiping off foreign substance and so forth can be listed. In the methods which use air like the sucking method or the blowing off method, the sucking direction or the blowing off direction is adjusted so that sucked air or blown off air may not be admitted into the space in which a series of processes are performed after picture material is applied to the surface of a printing plate by the applying apparatus until the application film of the applied picture material is dried by the drying apparatus.

Furthermore, the present plate making apparatus may further comprise a heating apparatus so that the clean air to be supplied from the clean air supplying apparatus may be heated. Where heated clean air of a high temperature is supplied to the plate face, the drying of the application film can be promoted. Therefore, the probability that dust may adhere to the application film before it is dried can be further reduced.

Preferably, the plate making apparatus further comprises, as the processing apparatus, a development station in which a development apparatus for developing a pattern written on the plate face of each printing plate, the development station including a supporting member disposed at the development station for supporting each printing plate in the form of a tube, and a supplying apparatus disposed at the development station for supplying processing liquid for development to the plate face of the printing plate supported by the supporting member. Accordingly, at the development station, a printing plate of an object of a development process is supported in the form of a tube by the supporting member, and the processing liquid for development is supplied by the supplying apparatus to the plate face of the printing plate in the state supported on the supporting member to develop the pattern written on the plate face of the printing plate.

With the plate making apparatus, since the development process can be performed outside a printing machine, the plate face of the printing plate or print paper is not contaminated by leakage or drop of the processing liquid or mist at all. Further, there is no necessity to take interference with ink rollers or a damping apparatus disposed around the printing cylinder into consideration, and the degree of freedom in space design is raised very high. Furthermore, since the development processing is performed off-line, it can be performed in parallel to printing by the printing machine, and the operating ratio of the printing machine can be enhanced.

Preferably, the tube is positioned on the upper side of the supplying apparatus at the development station, and the supplying apparatus supplies the processing liquid for development from the lower side of the tube to the plate face of the printing plate. The supplying apparatus includes a processing liquid supplying member configured from one or a plurality of rollers, a spray, or a slit formed from one or a plurality of plate materials and supplies the processing liquid for development to the printing plate through the processing liquid supplying member. Since the present development apparatus has a very high degree of freedom in space design as described above, it is possible to adopt such an arrangement as just described. With the arrangement, since the processing liquid can be supplied well to the plate face, a high development quality and reliability can be achieved.

Preferably, the pattern erasing apparatus is configured by arranging, around an outer periphery of the regenerative printing plate formed from a cylindrical face, a washing agent nozzle for injecting washing agent toward the plate face, a plate face rubbing apparatus for rubbing the plate face, a water nozzle for injecting water toward the plate face, and a liquid recovery apparatus for recovering the water on the plate face. With the plate making apparatus, the washing agent can be injected toward the plate face by the washing agent nozzle, and the plate face to which the washing agent is supplied can be rubbed by the rubbing apparatus. Further, water can be injected and supplied toward the plate face by the water nozzle, and the water on the plate face can be recovered by the liquid recovery apparatus. Consequently, an image of the regenerative printing plate can be erased with certainty in short processing time.

Preferably, the plate making apparatus further comprises a detection apparatus to detect an abnormal state (mechanical trouble, disappearance of a stop or the like) appearing in the plate making apparatus, and when an abnormal state is detected by the detection apparatus, a signal is automatically outputted to the outside from an out putting apparatus. With the plate making apparatus, the necessity for an operator to stay at the plate making apparatus is eliminated, and the restriction to the range of behavior of the operator is eliminated and the operability is enhanced. In this instance, more preferably the outputting apparatus is configured so as to automatically output an abnormal state signal to a portable terminal (portable telephone set, PHS or the like) of an operator through a telephone line. Where a telephone line is utilized in this manner, communication to the operator can be performed without providing a special infrastructure.

Further, in order to attain the objects described above, a second plate making apparatus of the present invention comprises a cylindrical carrier including a printing plate on an outer peripheral face thereof, a pair of chuck apparatus for fitting in openings at the opposite ends of the carrier to grasp the carrier from the opposite sides and centering the carrier with a predetermined reference axis, and one or a plurality of processing apparatus disposed in a direction toward the carrier centered by the chuck apparatus for performing a plate making process for the printing plate supported by the carrier, the carrier before processing being carried into a space between the pair of chuck apparatus from a perpendicular direction to the reference axis, the carrier after the plate making process being carried out from the space between the pair of chuck apparatus to a perpendicular direction to the reference axis. Where the printing plate is integrated with the outer peripheral face of the carrier in this manner, handling of the printing plate is facilitated and also damage to the printing plate can be prevented. Further, since the carrier is supported from the opposite sides thereof by the chuck apparatus, the space necessary for carry-in and carry-out of the carrier (exchange of a plate) can be reduced. Accordingly, the space necessary for installation of the apparatus can be reduced, and also automation of plate exchange is facilitated.

Further, in order to attain the objects described above, a first management method for a regenerative printing plate of the present invention is a management method for a regenerative printing plate which is used in a state wherein the regenerative printing plate is mounted on a cylindrical carrier. First, a printing plate identification number is applied to each regenerative printing plate while a carrier identification number is applied to each carrier, and a file for recording a use situation of each regenerative printing plate is produced for each plate identification number. Then, when each regenerative printing plate is to be used, the printing plate identification number thereof is recorded in a corresponding relationship to the carrier identification number of the carrier on which the regenerative printing plate is mounted into a table. Then, every time each regenerative printing plate is used, the carrier identification number is read from the carrier to search the printing plate identification number corresponding to the read carrier identification number from the table and, the use situation of the regenerative printing plate is recorded and updated into the file corresponding to the printing plate identification number. With such a method as just described, since each regenerative printing plate can be managed in accordance with a carrier identification number united to a printing plate identification, the printing plate identification number maybe applied, for example, to the rear face of the printing plate. Thus, the restriction in application of a printing plate identification number to a printing plate can be eliminated.

As a method of applying a carrier identification number to a carrier, for example, the number itself may be applied to a side face or the like of the carrier, or may be converted into and adhered as a bar code. More preferably, a radio reading type data storage device (microchip, IC tag or the like) is attached to each carrier and the carrier identification number is stored in the data storage device. With the management method for a regenerative printing plate, even under such a bad environment that the carrier is splashed with solvent, the identification number information is not lost at all. More preferably, the data storage device is embedded in the carrier.

Further, in order to attain the objects described hereinabove, according to a second management method for a regenerative printing plate of the present invention, use situation data is written on a plate face of a regenerative printing plate together with a pattern, and, when the pattern of the regenerative printing plate is to be rewritten, the use situation data of the plate face is read and temporarily stored into a memory before regeneration, and, after the regeneration, the use situation data temporarily stored in the memory is updated together with the new pattern and the use situation data is written on the plate face of the regenerative printing plate. Since the function of a regenerative printing plate is utilized to record data on the plate face in this manner, the necessity for an equipment for exclusive use for number application is eliminated.

Further, in order to attain the object described above, according to a third management method for a regenerative printing plate of the present invention, a printing plate identification number is applied to each regenerative printing plate and written on a plate face, and a file for recording a use situation of each regenerative printing plate is produced for each plate identification number. Then, when a pattern of each regenerative printing plate is rewritten, the plate identification number of the plate face is read and temporarily stored into a memory before regeneration, and then the use situation of the regenerative printing plate is recorded and updated into the file corresponding to the read out printing plate identification number. Then, after the regeneration, the printing plate identification number temporarily stored in the memory is written together with the new pattern on the plate face of the regenerative printing plate. Since the function of a regenerative printing plate is utilized to write the printing plate identification number every time regeneration is performed in this manner, reading of the printing plate identification number can be performed regardless of overwriting of a pattern.

An interstage sleeve of the present invention which can be applied to such printing plate apparatus and regenerative printing plate as described above is a cylindrical carrier having a printing plate provided on an outer peripheral face thereof and functions, when mounted on a center shaft provided in a printing machine, as a printing cylinder or a blanket drum of the printing machine, wherein a composite material of a microballoon material and a resin material is used as a configuration material.

Since the microballoon material has a low specific gravity and is superior in compressive resistance and heat resisting properties, where the composite material of such a microballoon material as just described and a resin material is used as a component material in this manner, an interstage sleeve having a reduced weight and a high strength as well as a high heat resisting property can be achieved. As the microballoon material, a resin material such as epoxy resin, glass such as soda lime silicate glass or ceramics can be used. Further, preferably the microballoons have a size (diameter) within a range of approximately 10 to 200 μm. Meanwhile, as the resin material which forms the composite material together with the microballoon material, all types of resin such as, for example, epoxy resin, unsaturated polyester resin, polyurethane resin, phenol resin, melamine resin and so forth can be used. Which one of the materials should be selected may be determined depending upon required characteristics, a molding method and so forth.

According to the present invention, the region of the interstage sleeve which is continuous in the circumferential direction is formed from the composite material described above. Accordingly, the interstage sleeve may be integrally formed from the composite material, or may be formed from a plurality of layers at least one of which is formed from the composite material. The content of the microballoon material in the composite material is preferably set higher than 50% if the specific gravity, compressibility and heat insulating properties are taken into consideration. In the latter case, the surface layer or a layer in the proximity of the surface may be formed from the composite material so as to make a heat insulating layer.

Since the interstage sleeve of the present invention is superior in heat insulating properties, it can be applied suitably as means for supporting a regenerative printing plate when the printing plate is processed for regeneration. The interstage sleeve has a regenerative printing plate provided on the surface thereof, and regeneration of the printing plate is performed in a state wherein the printing plate is provided as it is on the interstage sleeve. It is to be noted that, as a form in which the regenerative printing plate is provided on the interstage sleeve, a form wherein the surface itself of an interstage sleeve is formed as the printing plate, another form wherein a cylindrical printing plate having no seam is mounted on the interstage sleeve and a further form wherein a printing plate in the form of a flat plate is wrapped on and secured to the interstage sleeve are available. Any one of the forms can be adopted.

It is to be noted that a printing machine may include a center shaft on which such an interstage sleeve as described above is mounted such that, when the intermediate sleeve is mounted on the center shaft, it functions as a printing cylinder or a blanket drum. Then, exchange of a printing plate or exchange of a blanket is performed by dismounting the interstage sleeve from the center shaft and exchanging the interstage sleeve together with the printing plate or the blanket. Since the interstage sleeve has a light weight as described hereinabove, the exchanging operation upon printing plate exchange or blanket exchange is easy, and simultaneously since the interstage sleeve is superior in strength and is not deformed readily, a high printing accuracy can be achieved.

The interstage sleeve of the present invention can be formed in a dual structure including an outside sleeve and an inside sleeve removable from each other. In this instance, at least one of the outside sleeve and the inside sleeve is integrally formed from the composite material, or at least one of the outside sleeve and the inside sleeve is formed from a plurality of layers, and at least one of the layers is formed from the composite material. In the latter case, the surface of the outside sleeve or a layer in the proximity of the surface of the outside sleeve may be formed from the composite material so as to serve as a heat insulating layer.

Also the interstage sleeve having such a dual structure as described above is suitable as means for supporting a regenerative printing plate when the printing plate is processed for regeneration, and in this instance, the outer side sleeve functions as means for supporting a printing plate. Accordingly, upon plate exchange, it is necessary to exchange only the outside sleeve, and since the outside sleeve is lighter than the entire interstage sleeve including the inside sleeve in exchange, handling is easy.

Any of such interstage sleeves as described above may be used to form a printing machine as a variable cutoff printing machine. In particular, the printing machine includes a center shaft on which an interstage sleeve is to be mounted, and the interstage sleeve is mounted on the center shaft so that it functions as a printing cylinder or a blanket drum. Changing of the cutoff length is performed by exchanging the interstage sleeve with another interstage sleeve having a different outer diameter. Since the interstage sleeve is light in weight as described hereinabove, an exchanging operation for changing the cutoff length is easy, and simultaneously, since the interstage sleeve is superior in strength and is not deformed readily, a high printing accuracy can be achieved.

Further, an interstage sleeve of a dual structure which includes an outside sleeve and an inside sleeve may be used to form a printing machine as a variable cutoff printing machine. Also this printing machine includes a center shaft on which an interstage sleeve is to be mounted, and an intermediate sleeve is mounted on the center shaft so as to function as a printing cylinder or a blanket drum. In this printing machine, while changing of the cutoff length is performed by exchanging the interstage sleeve with another interstage sleeve having a different outer diameter, printing plate exchange or blanket exchange is performed by exchanging the outside sleeve together with the printing cylinder or the blanket. Since the frequency of printing cylinder exchange or blanket exchange is higher than the frequency of change of the cutoff length, where an interstage sleeve of a dual structure is used such that, upon printing cylinder exchange or blanket exchange, only the outside sleeve is exchanged in this manner, the burden in operation on the operator can be further reduced when compared with that in an alternative case wherein the entire interstage sleeve including the inside sleeve is exchanged.

### BRIEF DESCRIPTION OF THE DRAWINGS

FIG. 1 is a schematic view showing a configuration of a plate making apparatus as a first embodiment of the present invention;

FIG. 2 is a schematic view showing a structure of a carrier to which a printing plate is to be attached;

FIG. 3 is a schematic view showing an example of a structure of a chuck apparatus;

FIG. 4 is an explanatory view illustrating operation of the chuck apparatus of FIG. 3;

FIG. 5 is a schematic view showing another example of the structure of the chuck apparatus;

FIG. 6 is a schematic view showing a configuration of a carrier carry-in apparatus and a carrier carry-out apparatus;

FIG. 7 is a view as viewed in the direction of an arrow mark along line A-A of FIG. 6;

FIG. 8 is a block diagram showing a configuration of a management system for a regenerative printing plate as the first embodiment of the present invention;

FIG. 9 is a flow chart illustrating a management method for a regenerative printing plate as the first embodiment of the present invention;

FIG. 10 is a block diagram of an abnormal state notification system;

FIG. 11 is a schematic view showing a configuration of a plate making apparatus as a second embodiment of the present invention;

FIG. 12 is a schematic view showing a configuration of a plate making apparatus as a third embodiment of the present invention;

FIG. 13 is a block diagram showing a configuration of a management system for a regenerative printing plate as a fourth embodiment of the present invention;

FIG. 14 is a flow chart illustrating a management method for a regenerative printing plate as the fourth embodiment of the present invention;

FIG. 15 is a block diagram showing a configuration of a management system for a regenerative printing plate as a fifth embodiment of the present invention;

FIG. 16 is a flow chart illustrating a management method for a regenerative printing plate as the fifth embodiment of the present invention;

FIG. 17 is a schematic view showing a configuration of a first embodiment of a clean air supplying apparatus according to the present invention;

FIG. 18 is a schematic view showing a modification of the clean air supplying apparatus according to the present invention;

FIG. 19 is a schematic view showing a configuration of a second embodiment of a clean air supplying apparatus according to the present invention;

FIG. 20 is a view as viewed in the direction of an arrow mark along line A1-A1 of FIG. 19;

FIGS. 21(a) to 21(e) are schematic views of examples of a configuration of a processing liquid supplying apparatus;

FIG. 22 is a schematic block diagram showing a configuration of an image erasing apparatus for a regenerative printing plate according to the present invention;

FIG. 23 is a flow chart illustrating an image erasing method for a regenerative printing plate according to the present invention;

FIG. 24 is a schematic view showing a configuration of a printing machine and illustrating a first embodiment of an interstage sleeve according to the present invention;

FIG. 25 is a schematic transverse sectional view showing a configuration of the first embodiment of the interstage sleeve according to the present invention;

FIG. 26 is a schematic transverse sectional view showing a configuration of a second embodiment of the interstage sleeve according to the present invention;

FIG. 27 is a schematic transverse sectional view showing a configuration of an interstage sleeve according to a third embodiment of the interstage sleeve according to the present invention;

FIG. 28 is a schematic transverse sectional view showing a configuration of an interstage sleeve according to a fourth embodiment of the interstage sleeve according to the present invention;

FIG. 29 is a schematic exploded perspective view showing a configuration of an interstage sleeve according to a fifth embodiment of the interstage sleeve according to the present invention;

FIG. 30 is a schematic view showing a configuration of a conventional plate making apparatus;

FIG. 31 is a block diagram showing a configuration of a conventional management system for a regenerative printing plate; and

FIG. 32 is an explanatory view illustrating a subject of the conventional plate making apparatus.

### BEST MODE FOR CARRYING OUT THE INVENTION

In the following, embodiments of the present invention are described with reference to the drawings.

### [1] Description of the First Embodiment

In the following, an embodiment of the present invention is described with reference to the drawings.

(A) First Embodiment of the Plate Making Apparatus

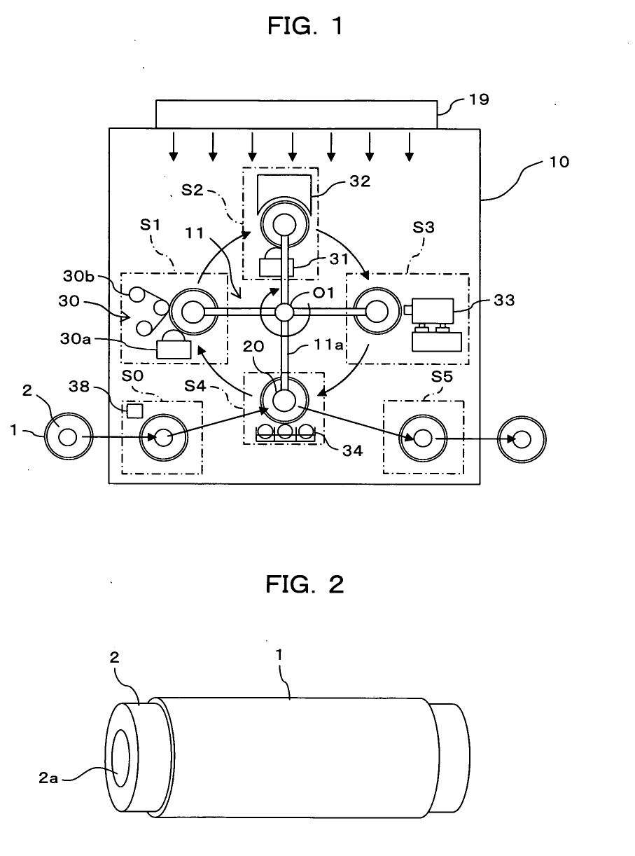

FIG. 1 is a schematic view showing a configuration of a plate making apparatus as a first embodiment of the present invention, and FIG. 2 is a view illustrating a form of handling of a printing plate according to the present embodiment. It is to be noted that, in the present embodiment, a printing plate is a regenerative printing plate which can be used repeatedly through rewriting of a pattern, and the plate making apparatus is constructed as a plate regeneration apparatus having a plate regeneration function together with a plate making function.

As shown in FIG. 2, a printing plate (regenerative printing plate) 1 is wrapped on and secured to an outer circumferential peripheral face of a cylindrical carrier 2. As the securing method of the printing plate 1 to the carrier 2, for example, a method similar to that used to secure a printing plate to a printing cylinder can be adopted. The carrier 2 has an axial length set greater than the transverse width of the printing plate 1 such that it projects to some degree at the opposite end portions thereof. It is to be noted that, although the printing plate 1 in the form of a flat plate here is wrapped on the outer circumferential peripheral face of the carrier 2, a cylindrical gapless printing plate having no seam may be mounted on the carrier 2 or the outer circumferential face itself of the carrier 2 may function as a regenerative printing plate.

A hole (opening) 2a is formed at a central portion of the carrier 2 such that it extends in an axial direction through the carrier 2. This hole 2a is utilized when the carrier 2 is handled by the plate making apparatus. The carrier 2 can be used not only as a tool for carrying the printing plate 1 but also as it is as a printing cylinder when mounted on a printing machine (not shown). Mounting of the carrier 2 on the printing machine can be performed by providing a rotary shaft at a location for a printing cylinder and fitting the rotary shaft into the hole 2a. It is to be noted that, for the carrier 2, a plurality of different carriers which have an equal inner diameter (diameter of the hole 2a) but have different outer diameters from each other are prepared. Although the print size or the cutoff depends upon the circumferential length of the printing cylinder, where the carriers 2 having different thicknesses are prepared in this manner, the circumferential length of the printing cylinder can be changed by changing the carrier 2 to a carrier of a different thickness, and also it is possible to cope with a change of the print size or the cutoff.

As shown in FIG. 1, the present plate making apparatus 10 is a so-called extra-machine plate making apparatus which is provided separately from the printing machine (not shown), and the carrier 2 on which the printing plate 1 is mounted is carried into the apparatus from the outside. Then, after regeneration and plate making processes of the printing plate 1, the carrier 2 is carried out to the outside. Since the plate making apparatus 10 is constructed as an extra-machine apparatus, a regeneration process of the printing plate 1 can be performed in parallel to printing by the printing machine. Further, although, in the case of an on-machine plate making apparatus, it is necessary to provide a plate making apparatus for each printing unit, in the case of an extra-machine plate making apparatus which is disposed separately from the printing machine like the plate making apparatus 10, also it is possible to prepare the single plate making apparatus 10 for a single printing machine and commonly use the plate making apparatus 10 among the printing units. Furthermore, also it is possible to prepare the single plate making apparatus 10 for a plurality of printing machines and commonly use the plate making apparatus 10 among the printing machines.

In the following, characteristics of the plate making apparatus 10 are described in detail. In the present plate making apparatus 10, carriers 2 carried in from the outside are first transported to a carry-in standby station S0 in the apparatus. Then, the carriers 2 are successively carried from the carry-in standby station S0 to a fourth processing station S4 by a transport apparatus such as a conveyor. In the plate making apparatus 10, four processing stations S1 to S4 are provided. The processing stations S1 to S4 are disposed at intervals of 90 degrees on a circle centered at a predetermined horizontal shaft O1, and the fourth processing station S4 is positioned at a lowermost position of the circle.

Different steps of a print making procedure are applied individually to the processing stations S1 to S4. In the present embodiment, since also a regeneration process of the printing plate 1 is performed, the print making procedure includes a pattern erasing step, a picture material applying step, a drying step, a pattern writing step and a developing step. Among the steps, the pattern erasing step is allocated to the first processing station S1; the picture material applying step and the drying step are allocated to the second processing station S2; the pattern writing step is allocated to the third processing station S3; and the developing step is allocated to the fourth processing station S4. It is to be noted that the steps described above are a mere example at all, and the number of processing stations may be increased or decreased or the allocation of the steps to the processing stations may be changed depending upon the plate making method or the regeneration method.

Processing apparatus corresponding to the allocated steps are installed at the individual processing stations S1 to S4. First, a cleaning apparatus 30 is installed at the first processing station S1. The cleaning apparatus 30 includes a water washing apparatus 30a and a fabric washing apparatus 30b and washes off ink, dampening solution, paper powder and so forth adhering to the plate face of the printing plate 1 with water and then wipes off the ink on the plate face using a roller around which a fabric-like article is wrapped. An applying apparatus 31 and a drying apparatus 32 are installed at the second processing station S2. The applying apparatus 31 applies a bar coater to the plate face of the printing plate 1 by means of a roller, and the drying apparatus 32 heats and dries the bar coater by means of heat of a halogen lamp. A laser writing apparatus 33 is installed at the third processing station S3. The laser writing apparatus 33 illuminates laser light on the plate face of the printing plate 1 to write a new pattern on the plate face of the printing plate 1. Further, a development apparatus 34 is installed at the fourth processing station S4. The development apparatus 34 applies developing solution to the plate face of the printing plate 1 by means of a roller and further applies fixing solution to develop the pattern written by the laser writing apparatus 33. The processing apparatus 30 to 34 have positions which can be adjusted in accordance with the thickness of the carrier 2 by a position adjusting apparatus not shown. Since a carrier having a thickness corresponding to the print size or the cutoff of the printing plate 1 to be mounted thereon is selectively used for the carrier 2 as described hereinabove, it is possible to cope with the carriers 2 having various sizes by making it possible to adjust the positions of the processing apparatus 30 to 34. It is to be noted that the processing apparatus 30 to 34 listed above are a mere example at all, and it is naturally possible to dispose a different processing apparatus depending upon the processing contents at each step.

Since the steps are allocated to the individual processing stations S1 to S4 in accordance with the order of the plate making procedure as described above, carriers 2 carried in to the fourth processing station S4 are successively carried to the first processing station S1, second processing station S2 and third processing station S3, by which they undergo the respective processes, and are finally carried to the fourth processing station S4, at which they undergo the developing process, whereafter they are carried to the carry-out standby station S5. The carry-out standby station S5 is provided on the opposite side to the carry-in standby station S0 across the fourth processing station S4, and the carriers 2 are successively carried to the outside from the carry-out standby station S5.

Since the plate making procedure is divided into a plurality of steps which are individually processed at the processing stations S1 to S4 different from each other as described above, a plurality of carriers 2 can be processed parallelly at intervals of time. In particular, for example, while the picture material applying/drying processes are performed for a first carrier 2 at the second processing station S2, the pattern erasing process for a second carrier 2 is performed at the first processing station S1. Then, simultaneously when the first carrier 2 is transported from the second processing station S2 to the third processing station, the second carrier 2 is transported from the first processing station S1 to the second processing station S2 so that the first and second carriers 2 are subject to the respective next processes. According to such parallel processing as just described, if it is assumed that two minutes are required for a process at each processing station, then while conventionally it is possible to make only one printing plate 1 in 2 minutes×4=8 minutes because the processes are performed at one place, one printing plate 1 can be made in two minutes. In short, according to the plate making apparatus 10, the operating ratio of the processing apparatus 30 to 34 can be raised by the parallel processing at intervals of time, and even if the processing speed of each processing apparatus is equal to that of the conventional apparatus, a high processing speed as a whole can be obtained.

It is to be noted that, according to such parallel processing as described above, a carrier 2 cannot be transmitted to a next station before the processes at all of the processing stations S1 to S4 are completed. Accordingly, where the processing times at the processing stations S1 to S4 have a dispersion, for example, where the processing time at only one station is longer, waiting time appears at the other processing stations and also the processing speed of the overall apparatus does not rise. Accordingly, in order to make the most of the advantage of the parallel processing, it is necessary to set the allocation of the steps to the processing stations S1 to S4, to set the processing capacities of the processing apparatus 30 to 34 or to set the number of processing stations so that the processing times at the processing stations S1 to S4 may be substantially equal to each other.

Further, the plate making apparatus 10 includes a contrivance also in an apparatus for supporting a carrier 2 in the plate making apparatus 10. In the present plate making apparatus 10, a carrier 2 is supported by a pair of chuck apparatus 20 on the opposite sides. The chuck apparatus 20 are provided on a transport apparatus 11 for transporting the carriers 2. The transport apparatus 11 includes arms (rotary member) 11a supported at intervals of 90 degrees for rotation on the horizontal shaft O1, and the chuck apparatus 20 are individually attached to free end portions of the arms 11a. The transport apparatus 11 rotates the arms 11a by 90 degrees in a timed relationship with completion of the processes at the processing stations S1 to S4. A carrier 2 transported from the carry-in standby station S0 to the fourth processing station S4 is mounted on the chuck apparatus 20 and set to the transport apparatus 11 at the fourth processing station S4 and then, after it goes round in the circuit together with rotation of the arm 11a, it is removed from the chuck apparatus 20 at the fourth processing station S4 and transported to the carry-out standby station S5.

Further, the chuck apparatus 20 serve also as a shaft portion on and from which a carrier 2 is to be mounted and dismounted and construct a supporting member for supporting a printing plate 1 together with a carrier 2. When a carrier 2 is mounted on the chuck apparatus 20, centering of the carrier 2 is performed, and positioning of the printing plate 1 at each of the processing stations S1 to S4 is performed.

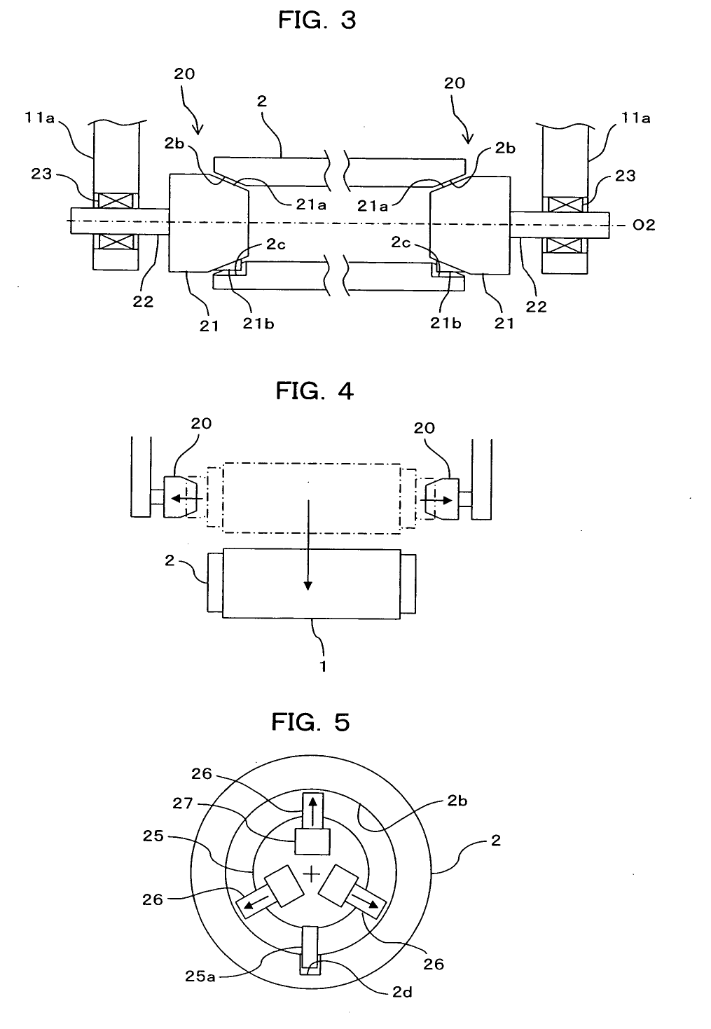

FIG. 3 shows an example of a structure of the chuck apparatus 20. Each of the chuck apparatus 20 has a rotary shaft 22 supported for rotation on an arm 11a through a bearing 23, and a clutch 21 is provided at a free end portion of the rotary shaft 22. The clutch 21 has a conical face 21a formed thereon, and the left and right clutches 21, 21 are adjusted in position to a predetermined reference axis O2 parallel to the aforementioned horizontal shaft O1. Each of the clutches 21, 21 can be moved back and forth in a direction of an axial line thereof by an actuator not shown.

The clutches 21, 21 are engaged with openings on the opposite sides of the hole 2a provided at the central portion of each carrier 2 to grasp the carrier 2 from the opposite sides. Conical faces 2b are formed also at the openings of the carrier 2, and the axial lines of the conical faces 2b coincide with the axial line of the carrier 2. Consequently, when the conical faces 21a of the clutches 21 are engaged with the conical faces 2b at the openings of the carrier 2, centering of the carrier 2 with the reference axis O2 is performed automatically. Positioning of the carrier 2 in the direction of rotation may be performed such that, for example, a groove 2c is provided at each of the conical faces 2b at the openings of the carrier 2 while a key 21b is provided on the conical face 21a of each of the clutch 21 and the keys 21b and the grooves 2c are engaged with each other.

It is to be noted that, while, at the processing stations S1 to S4, the processing apparatus 30 to 34 perform the plate making processes for printing plates 1 while the carriers 2 are rotated, the rotation of the carriers 2 then is performed by driving force transmitted from a motor not shown to the rotary shafts 22 of the chuck apparatus 20. This motor may be provided for each of the chuck apparatus 20 on the transport apparatus 11 or otherwise be provided at each of the processing stations S1 to S4.

Where a carrier 2 is supported from the opposite sides thereof and handled by the chuck apparatus 20 in this manner, the carriers 2 can be carried into and out of the fourth processing station S4 which is a carry-in and carry-out station from a direction of the front face of the apparatus (direction perpendicular to the reference axis O2) as shown in FIG. 4. Accordingly, according to the present plate making apparatus 10, when compared with an alternative case wherein the support drum 101 is placed in and out in an apparatus widthwise direction from the bearing 103 (refer to FIG. 32), the space necessary for carry-in and carry-out (plate exchange) of a carrier 2 can be reduced, and there is an advantage that the restriction in the apparatus widthwise direction in installation of the plate making apparatus 10 is reduced.

The configuration of the chuck apparatus 20 described hereinabove is a mere example at all, and it is possible to adopt some other configuration, for example, such a configuration as shown in FIG. 5. The configuration of FIG. 5 is such that at least three or more pawls 26 which are moved back and forth in diametrical directions are provided on a clutch 25 such that the pawls 26 are engaged with an inner circumferential face of the hole 2a of a carrier 2. According to this configuration, a carrier 2 can be automatically centered with the reference axis O2 by controlling actuators 27 for moving forwardly and backwardly the pawls 26 such that they have elongation amounts equal to each other. Also in this instance, by causing keys 25a provided on the clutches 25 to engage with grooves 2d provided on the carrier 2, positioning of the carrier 2 in the direction of rotation can be performed.

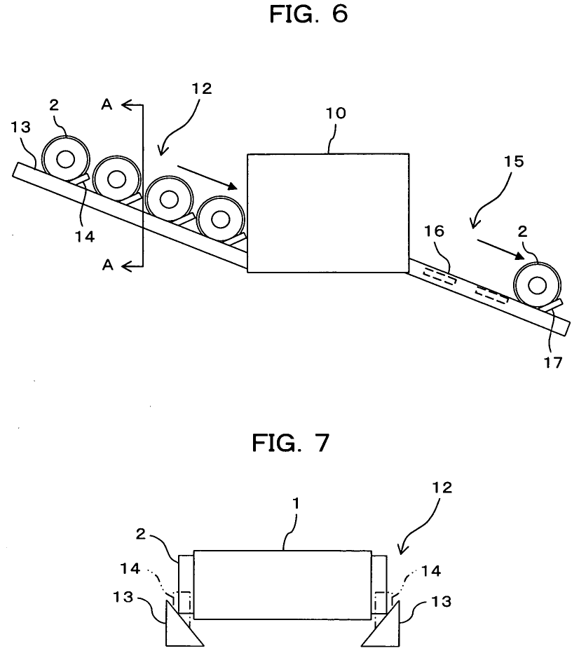

FIGS. 6 and 7 are schematic views showing a configuration of a carrier carry-in apparatus and a carrier carry-out apparatus combined with the present plate making apparatus. The carrier carry-in apparatus 12 includes a pair of left and right rails 13 and a plurality of stoppers 14 provided on the rails 13. The two rails 13, 13 are disposed at distances adjusted such that they support the opposite end portions of the carriers 2 and are provided in an inclined relationship so that the carriers 2 may roll toward the plate making apparatus 10. The rails 13 function also as a loading machine for automatically loading a carrier 2 into the plate making apparatus 10 and function also as a before-processing stock section for stocking a plurality of carriers 2 before the plate making process. Supporting faces of the rails 13 on which a carrier 2 is to be supported are formed in a V-shape so that positioning of a carrier 2 in an apparatus widthwise direction may be performed simply.

The stoppers 14 are provided for prevention of rolling and positioning of the carriers 2 on the rails 13 and engage with marginal portions at the opposite end portions of a carrier 2 around which the printing plate 1 is not wrapped. The stoppers 14 are attached so as to be tilted forwardly such that, when the stoppers 14 are tilted, the carriers 2 can roll along the rails 13 and successively move forwardly. The stoppers 14 are erected and tilted by an actuator not shown, and the erecting/tilting motions of the stoppers 14 are interlocked with movements of the carriers 2 in the plate making apparatus 10. In particular, simultaneously when a carrier 2 at the carry-in standby station S0 is transported to the first processing station S1, the stoppers 14 are tilted to feed a carrier 2 from the rails 13 into the carry-in standby station S0, and at a point of time when the carriers 2 on the rails 13 advance by one pitch, the stoppers 14 are erected uprightly to stop the rolling of the carriers 2.

According to the carrier carry-in apparatus 12 having such a configuration as described above, since the carriers 2 can be stocked on the rails 13, incessant successive carry-in of the carriers 2 can be achieved, and the processing capacity can be further raised. Further, since the carrier carry-in apparatus 12 has the simple configuration of the rails 13 and the stoppers 14, only a low cost is required, and besides, since the carriers 2 can be carried into the print making apparatus 10 from a direction of the front face of the apparatus, also the installation space of the carrier carry-in apparatus 12 can be reduced. Further, since the rails 13 support the opposite end portions of the carriers 2, a printing plate 1 provided on the outer circumferential face of a carrier 2 is not damaged at all.

On the other hand, the carrier carry-out apparatus 15 includes a pair of left and right rails 16 and a plurality of stoppers 17 provided on the rails 16 similarly to the carrier carry-in apparatus 12. The structure of the rails 16 and the stoppers is the same as that of the carrier carry-in apparatus 12. The rails 16 function as an after-processing stock section for stocking carriers 2 after the plate making process. The stoppers 17 are tilted immediately before a carrier 2 is carried out from the carry-out standby station S5 so that the carriers 2 on the rails 16 are rolled along the rails 16, and then at a point of time after the carriers 2 advance by one pitch, the stoppers 17 are controlled so as to be erected uprightly again to stop the rolling of the carriers 2.

According to the carrier carry-out apparatus 15 having such a configuration as described above, since carriers 2 after the print making process can be stocked on the rails 16, an operator need not stay at the plate making apparatus 10 any more in order to receive a carrier 2 after the print making process, and the operability is enhanced significantly. Further, since the carrier carry-out apparatus 15 has the simple configuration of the rails 16 and the stoppers 17 similarly to the carrier carry-in apparatus 12, a reduced cost is required, and besides, since a carrier 2 can be taken out in a direction of the front face of the apparatus from the plate making apparatus 10, the installation space maybe small. Further, since the rails 16 support the opposite end portions of the carriers 2, the printing plates 1 provided on the outer circumferential face of each of the carrier 2 is not damaged at all.

While the principal components of the present plate making apparatus 10 are described above, the present plate making apparatus 10 further includes a clean air supplying apparatus 19 for supplying clean air into the apparatus 10 as shown in FIG. 1. While bar coater is applied to a printing plate 1 and dried at the second processing station S2, if a foreign article adheres to the plate face, then the influence of the foreign article appears as a print defect upon printing. Therefore, in the present plate making apparatus 10, clean air (for example, air of a cleanliness of 1,000 or more) is continuously supplied into the plate making apparatus 10 by the clean air supplying apparatus 19 to prevent adhering of a foreign article to the plate face thereby to prevent deterioration of the print quality. It is to be noted that, although clean air is supplied to the entire inside of the plate making apparatus 10, clean air may otherwise be supplied restrictively to a location around the carrier 2, that is, to a location around a printing plate 1 at least for a period of time while bar coater is applied to the printing plate 1 and dried.

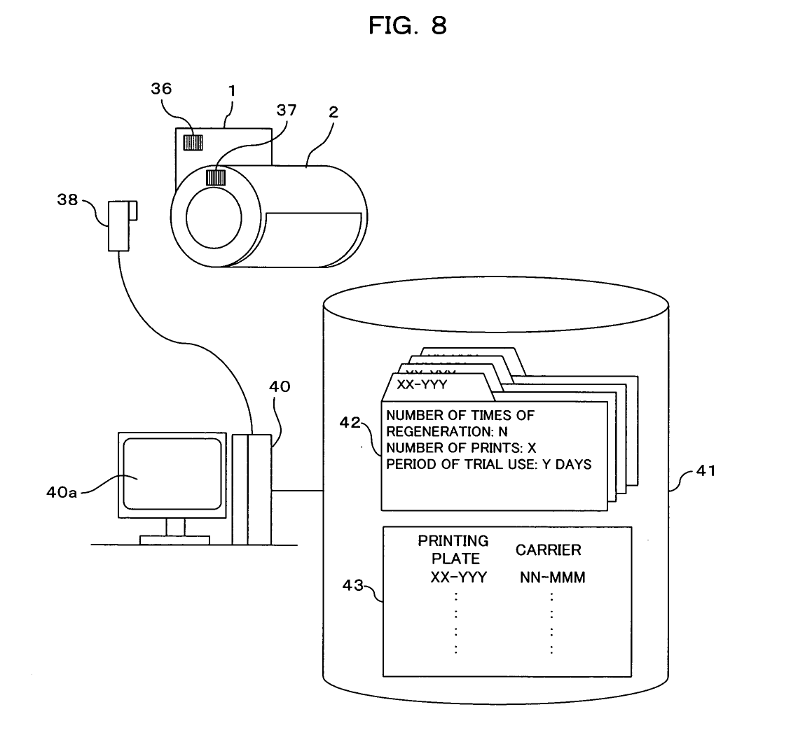

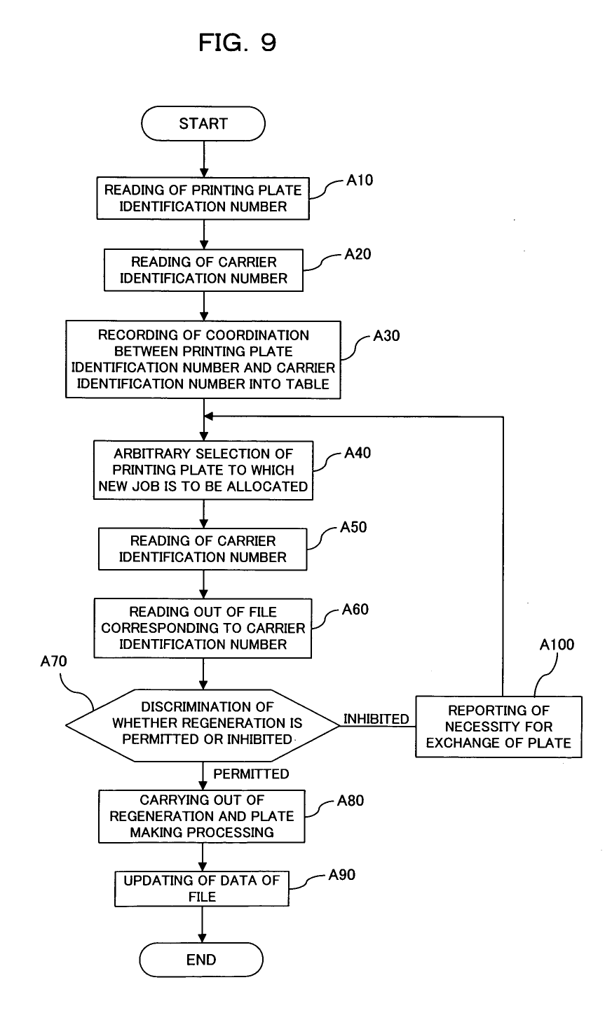

Now, a management method for a printing plate 1 according to the present embodiment is described. In the present embodiment, taking notice of the fact that a printing plate 1 is normally handled integrally with a carrier 2, management of printing plates 1 is performed by the following method. It is to be noted that the management method according to the present embodiment is a method which is applied to a printing plate 1 which can be removed from a carrier 2, but a carrier 2 whose circumferential face itself functions as a printing plate does not make an object of application of the management method according to the present embodiment. In the following, the management method is described in accordance with a flow chart of FIG. 9 with reference to a system block diagram of FIG. 8.

First, as a pre-process, a printing plate identification number is applied to each printing plate 1 while a carrier identification number is applied to each carrier 2 as shownin FIG. 8. As a number application method of the identification numbers to each printing plate 1 and each carrier 2, the identification numbers are converted into bar codes and bar code seals 36 and 37 are adhered to them, respectively. In FIG. 8, the bar code seal 36 is adhered to the rear surface of the printing plate 1 while the bar code seal 37 is adhered to a side face of the carrier 2. Further, a computer 40 having a function for discriminating a use situation of the printing plate 1 (whether regeneration is permitted or inhibited) (the function corresponds to a decision apparatus according to the present invention) is provided. In a database 41 of the computer 40, a file 42 for recording a use situation (regeneration time number, print number, use period and so forth) of each printing plate 1 is produced for each printing plate identification number. Also a table 43 for coordinating the printing plate identification numbers and the carrier identification numbers is produced in the database 41.

Then, when a printing plate 1 is to be used, the printing plate identification number is read from the bar code seal 36 by a bar code reader 38 (step A10), and the carrier identification number is read from the bar code seal 37 of the carrier 2 on which the printing plate 1 is mounted (step A20). Then, the printing plate identification number and the carrier identification number read in this manner are recorded in a coordinated relationship with each other into the table 43 (step A30)

Then, when it is tried to allocate a new job to the printing plate 1 (step A40), the carrier identification number is read from the carrier 2 (step A50), and the printing plate identification number corresponding to the thus read carrier identification number is searched out from the table 43 and the file 42 corresponding to the printing plate identification number is read out from the database 41 (step A60). Thereafter, it is decided whether regeneration of the printing plate 1 is permitted or inhibited from the use situation up to the present time recorded in the file 42 (step A70). If it is decided that regeneration of the printing plate 1 is inhibited, then it is displayed on a display unit 40a that plate exchange is required for the printing plate 1 (step A100). On the other hand, if it is decided that regeneration of the printing plate 1 is permitted, then regeneration and plate making processes are performed for the printing plate 1 by the plate making apparatus 10 (step A80), and data of the substance (print number and so forth) of the job in the present cycle, the number of times of regeneration and so forth are recorded into the file 42 to update the file 42 (step A90).

According to such a method as described above, since a printing plate 1 can be managed with a carrier identification number coordinated with the printing plate identification thereof, the printing plate identification number may be applied to the front surface of the printing plate 1 as described hereinabove, and the restriction in application of a printing plate identification number to a printing plate 1 can be eliminated. Further, since there is no necessity to remove the printing plate 1 from the carrier 2 for the confirmation of the printing plate identification number every time a regeneration process is performed, it is possible to suppress damage to the printing plate 1. Accordingly, according to the present method, management of the printing plates 1 is facilitated.

It is to be noted that the decision of whether regeneration before the plate making process by the plate making apparatus 10 is permitted or inhibited is preferably carried out before the carrier 2 is carried to the processing stations S1 to S4. In the case illustrated in FIG. 1, the bar code reader 38 is provided at the carry-in standby station S0 and reads the carrier identification and decided permission or inhibition of regeneration of the printing plate 1 with regard to all of the carriers 2 carried in from the carrier carry-in apparatus 12. Then, if it is decided that regeneration of the printing plate 1 is permitted, then the carrier 2 for the printing plate 1 is carried to the fourth processing station S4 whereas, if it is decided that regeneration of the printing plate 1 is inhibited, then the carrier 2 for the printing plate 1 is taken away from the line (this function element corresponds to a selection apparatus according to the present invention) and a new carrier 2 is carried to the carry-in standby station S0 from the carrier carry-in apparatus 12. Where it is decided whether or not regeneration of the printing plate 1 is appropriate to select a carrier 2 in this manner, wasteful processing does not occur in the plate making apparatus 10, and the substantial processing capacity can be further enhanced.

As the method of applying a carrier identification number to a carrier 2, not only the method of adhering such a bar code seal 37 as described above but also another method of attaching a data storage device such as a microchip or an IC tag in which the carrier identification number is stored to the carrier 2 are available. Although there is the possibility that, under an environment wherein printing is performed, a carrier 2 may be splashed with solvent or the like, where the carrier identification number is stored in the data storage device, the identification number information is not lost at all even under such an environment as just described.

Finally, an abnormal state notification method in the present embodiment is described. In the present embodiment, the plate making apparatus 10 performs full automatic processing, and carriers 2 are automatically carried into the plate making apparatus 12 from the carrier carry-in apparatus 12 and the carriers 2 after the print making process are automatically stocked in the carrier carry-out apparatus 15. Therefore, fundamentally there is no necessity for an operator to stay at the print making apparatus. However, if a countermeasure cannot be taken rapidly when some abnormal state such as a mechanical trouble or shortage in stock of carriers 2 occurs, then the operating ratio of the plate making apparatus 10 drops. Accordingly, a system is required which can issue, when some abnormal state occurs with the plate making apparatus 10, a notification of the abnormal state rapidly to the operator.

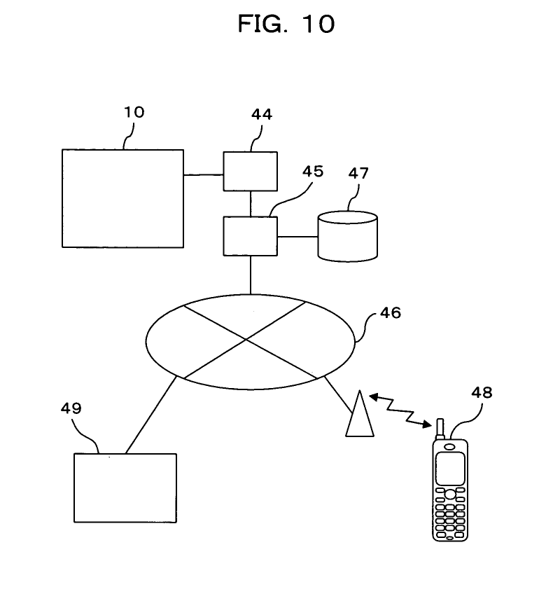

In the present embodiment, the abnormal state notification system is constructed making use of an existing telephone network. In particular, as shown in FIG. 10, the plate making apparatus 10 is connected to a telephone network 46, and a telephone number of a portable terminal 48 (portable telephone set, PHS or the like) of the operator, a telephone number of a maintenance company 49 and so forth are registered in a database 47. Then, when some abnormal state is detected by an abnormal state detection apparatus 44, an outputting apparatus 45 searches the database 47 for a communication destination suitable for the substance of the detected abnormal state and issues a notification of the abnormal state to the communication destination through the telephone network 46.

According to such an abnormal state notification method as described above, the necessity for an operator to normally stay at the plate making apparatus 10 is eliminated, and the restriction to the sphere of activity of the operator is eliminated and the operability is enhanced. Further, since an existing telephone network is utilized, there is no necessity to maintain a special infrastructure, and also the maintenance cost of the system can be suppressed low. It is to be noted that, while a telephone network is utilized here, where a LAN is constructed already on the premises, a notification of an abnormal state may be issued to the portable telephone terminal of the operator through the LAN.

(B) Second Embodiment of the Plate Making Apparatus

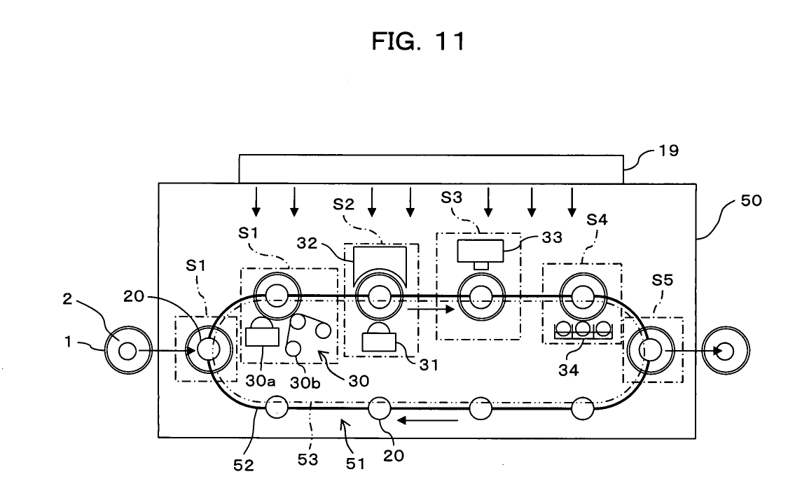

FIG. 11 is a schematic view showing a configuration of a plate making apparatus as a second embodiment of the present invention. As shown in FIG. 11, the present plate making apparatus 50 is characterized in that processing stations S1 to S4 are disposed on a substantially horizontally line in order of the first processing station S1, second processing station S2, third processing station S3 and fourth processing station S4 in accordance with the order of the plate making procedure. Processing apparatus 30 to 34 described hereinabove in connection with the first embodiment are disposed at the processing stations S1 to S4. The allocation of the steps of the plate making procedure to the processing stations S1 to S4 is the same as that in the first embodiment, and also the functions of the processing apparatus 30 to 34 are the same as those in the first embodiment.

In the present embodiment, a chain (caterpillar member) 52 is used as a transport apparatus 51 for transporting carriers 2. A horizontally elongated elliptical guide 53 is disposed in the plate making apparatus 50. The chain 52 is circulated around the guide 53 by an actuator not shown. The processing stations S1 to S4 are arranged along an upper side of the elliptical track drawn along the guide 53 by the chain 52. Further, the carry-in standby station S0 and the carry-out standby station S5 are arranged at the opposite front and rear ends of the elliptical track. The distances between adjacent ones of the stations from the carry-in standby station S0 to the carry-out standby station S5 through the processing stations S1 to S4 are equal to each other, and a plurality of chuck apparatus 20 are attached at equal pitches equal to the distance between the stations to the chain 52. The chuck apparatus 20 have a configuration and functions similar to those described hereinabove in connection with the first embodiment.

According to such a configuration as described above, a carrier 2 carried into the plate making apparatus 50 from the outside is mounted on chuck apparatus 20 at the carry-in standby station S0 at the front end of the line and is then fed successively to the processing stations S1 to S4 by circulation of the chain 52. It is to be noted that the transport apparatus 51 moves the chain 52 one by one pitch in response to completion of processes at the processing stations S1 to S4. Then, when the processes at the all processing stations S1 to S4 are completed and the carrier 2 is carried to the carry-out standby station S5 at the rear end of the line, the carrier 2 is removed there from the chuck apparatus 20 and carried out to the outside from the carry-out standby station S5. It is to be noted that, also in the present plate making apparatus 50, the carrier carry-in apparatus 12 and the carrier carry-out apparatus 15 described hereinabove in connection with the first embodiment can be used as means for carrying in and out the carriers 2. Further, selection of a carrier 2 depending upon decision of permission or inhibition of regeneration of the printing plate 1 thereon may be performed before the carrier 2 is mounted on chuck apparatus 20 at the carry-in standby station S0.

According to the present plate making apparatus 50, since the chain 52 is used as the transport means for the carriers 2, the degree in layout of the stations S0 to S5 is raised. Further, since all of the stations S0 to S5 are disposed in a juxtaposed relationship on the line, accessing from the lower side of the apparatus which is advantageous for liquid operation can be performed at all of the processing stations S1 to S4, and there are advantages that the operability is enhanced and that the contamination of a printing plate 1 or the apparatus by dropping liquid from the water washing apparatus 30a or the development apparatus 34 can be prevented.

(C) Third Embodiment of the Plate Making Apparatus

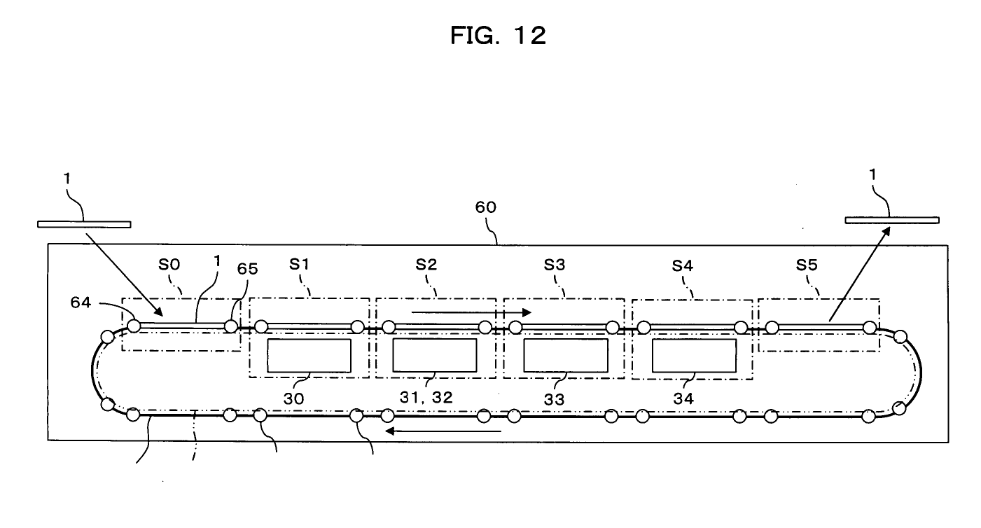

FIG. 12 is a schematic view showing a configuration of a plate making apparatus as a third embodiment of the present invention. The present embodiment is characterized in that a printing plate is not handled in a state wherein it is attached to a carrier but plate making is performed while a printing plate is handled in the form of a flat plate.

As shown in FIG. 12, a transport line for printing plates 1 is provided horizontally within the present plate making apparatus 60, and processing stations S1 to S4 are disposed along the transport line in order of the first processing station S1, second processing station S2, third processing station S3 and fourth processing station S4 in accordance with the order of the plate making procedure. A printing plate 1 is transported while a horizontal posture is maintained with the plate face thereof directed downwardly, and processing apparatus 31 to 34 are disposed on the lower side of the transport line. Further, a carry-in standby station S0 for carrying in printing plates 1 to the transport line is provided on the upstream side of the first processing station S1, and a carry-out standby station S5 for carrying out and in the printing plates 1 from the transport line is provided on the downstream side of the fourth processing station S4.

In the present plate making apparatus 60, a chain 62 is used as a transport apparatus 61 for feeding the printing plates 1. A guide 63 is provided along the transport line in the plate making apparatus 60, and the chain 62 is circulated by an actuator not shown along the guide 63. A plurality of pairs of grip apparatus 64 and 65 for gripping upper and lower ends of a printing plate 1 to fix the printing plate 1 are attached to the chain 62. The distances between adjacent ones of the stations S0 to S5 are set equal to each other, and the pairs of the grip apparatus 64 and 65 are attached at equal pitches in accordance with the distances between the stations. The transport apparatus 61 moves the chain 62 one by one pitch in response completion of processes at the processing stations S1 to S4.

In this manner, according to the present plate making apparatus 60, printing plates 1 can be processed parallelly while they remain in the form of a flat plate without being attached to a carrier.

(D) Fourth Embodiment of the Plate Making Apparatus

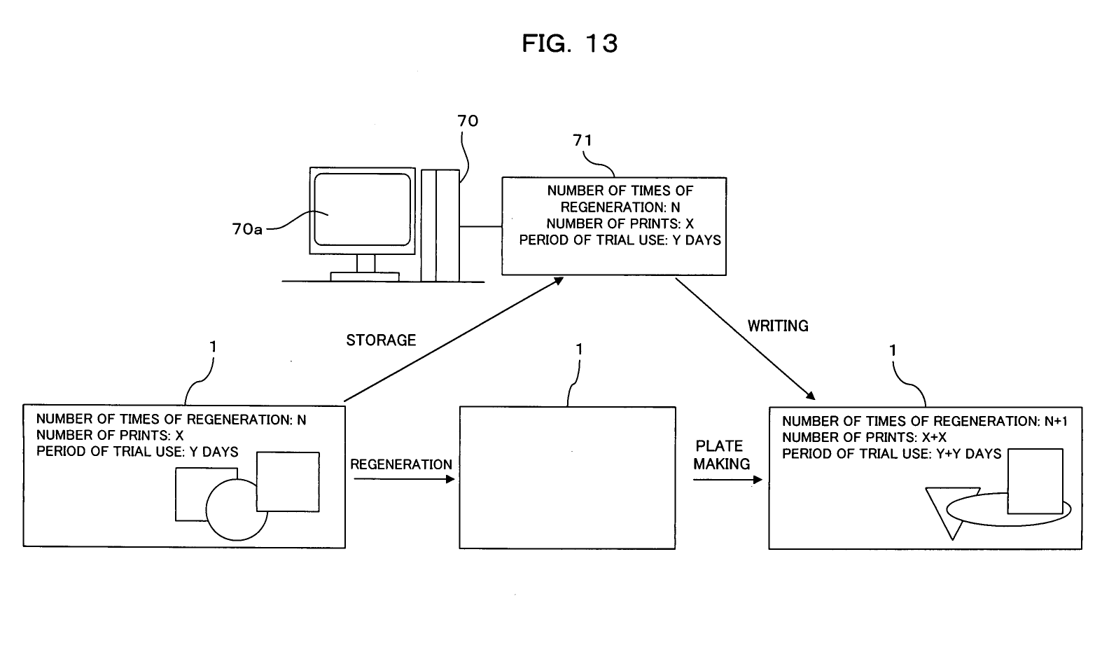

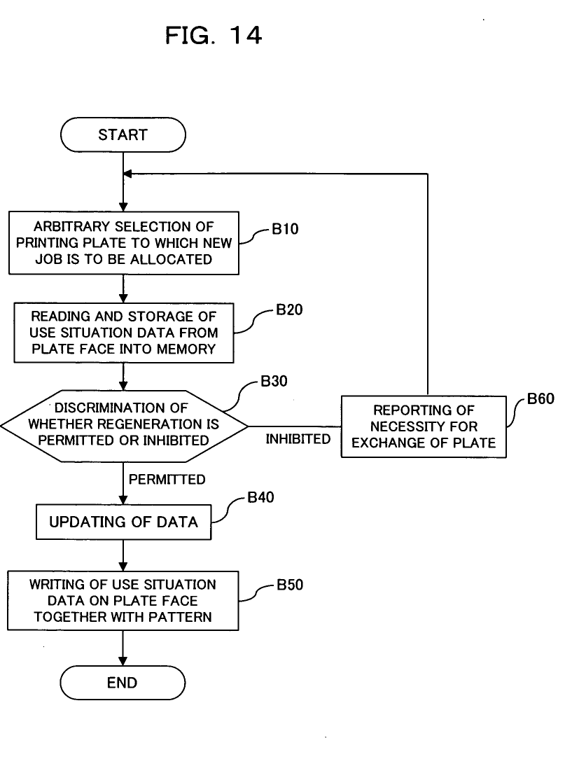

Now, plate making apparatus as a fourth embodiment of the present invention is described in accordance with a flow chart of FIG. 14 with reference to a system block diagram of FIG. 13. The present management method can be applied not only to a case wherein a printing plate is normally handled integrally with a carrier as in the first embodiment or the second embodiment but also to another case wherein a printing plate is handled by itself while it remains in the form of a flat plate as in the third embodiment. Further, the management method according to the present embodiment can be applied also to a carrier whose outer circumferential face itself functions as a printing plate.

First, as a pre-process, a region for writing use situation data (the number of times of regeneration, number of prints, period of use and so forth) of each printing plate 1 is provided on the plate face of the printing plate 1 as shown in FIG. 13. Writing of data is performed, for example, with the plate making apparatus of the first to third embodiments, together with writing of a pattern by a laser writing apparatus. Further, a memory 71 for temporarily storing such use situation data is prepared in a computer 70.

Then, when a new job is to be allocated to a printing plate 1 (step B10), the use situation data are read out from the plate face of the printing plate 1 and temporarily stored into the memory 71 prior to regeneration (step B20). Reading of the user situation data can be performed, for example, where the use situation data are indicated by a bar code, using a bar code reader. Then, it is decided from the use situation up to the present time thus read whether regeneration of the printing plate 1 is permitted or inhibited (step B30). If it is decided that regeneration of the printing plate 1 is inhibited, then this is displayed on a display unit of a computer not shown (step B60). On the other hand, if it is decided that regeneration of the printing plate 1 is permitted, then data regarding the substance (print number and so forth) of the job in the present cycle and the number of times of regeneration are added to the use situation data temporarily stored in the memory 71 to update the use situation data (step B40). Then, regeneration of the plate face of the printing plate 1 is performed, and the updated use situation data are written on the plate face together with the new pattern (step B50).

According to such a method as described above, since data are recorded on the plate face of the printing plate 1, there is no necessity to apply an identification number as in the conventional apparatus, and the necessity for an equipment for exclusive use for the number application is eliminated. In other words, according to the present method, the functions of the printing plate 1 can be utilized effectively. Further, even where regeneration and plate making processes are performed while the printing plate 1 is in a state wherein it is attached to a carrier, there is no necessity to remove the printing plate 1 from the carrier in order to confirm the identification number either. Consequently, also damage to the printing plate 1 can be suppressed.

(E) Fifth Embodiment of the Plate Making Apparatus

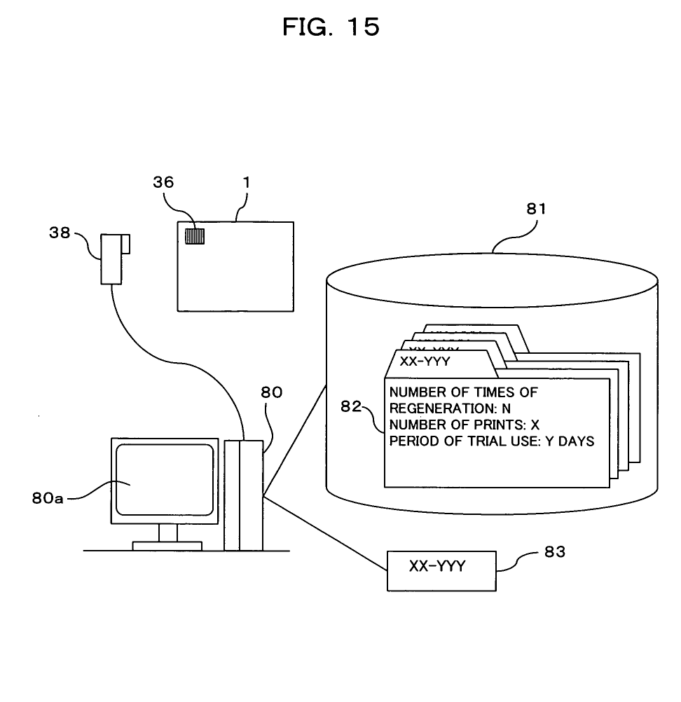

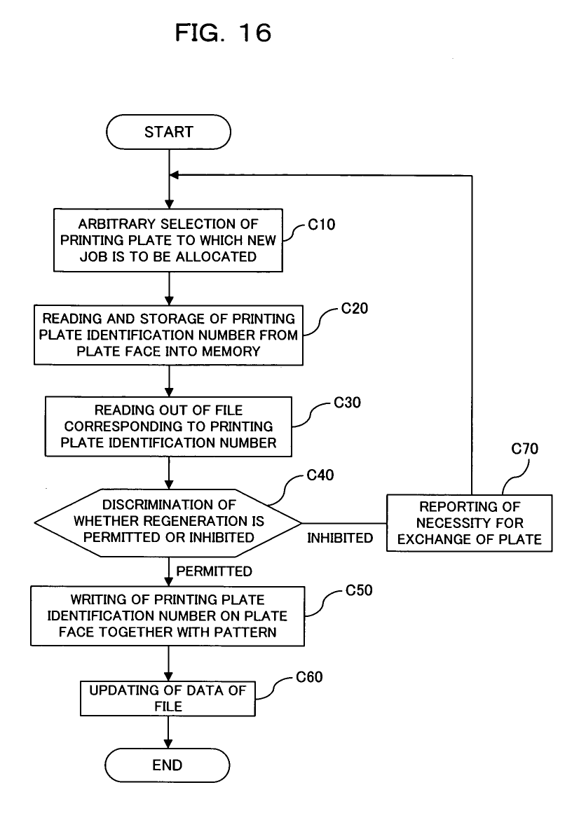

Now, a plate making apparatus as a fifth embodiment of the present invention is described in accordance with a flow chart of FIG. 16 with reference to a system block diagram of FIG. 15. The present management method can be applied also to a case wherein a printing plate is handled by itself while it remains in the form of a flat plate similarly as in the fourth embodiment. Also the management method according to the present embodiment can be applied to a carrier whose outer circumferential face itself functions as a printing plate.

First, as a pre-process, a printing plate identification number is written on the plate face of each printing plate 1 as shown in FIG. 15. For example, in the plate making apparatus of the first to third embodiments, the writing of a printing plate identification number is carried out together with writing of a pattern by a laser writing apparatus. The printing plate identification number may be represented, for example, by a bar code 36. Further, a memory 83 for temporarily storing the printing plate identification number is prepared in a computer 80, and a file 82 for recording a use situation (the number of prints, allocated job, number of times of regeneration and so forth) of each printing plate 1 is prepared for each printing plate identification number in a database 81 of the computer 80.

Then, when a new job is to be allocated to a printing plate 1 (step C10), the printing plate identification number is read from the plate face of the printing plate 1 and temporarily stored into the memory 83 prior to regeneration (step C20). The reading of the printing plate identification number can be performed, where the printing plate identification number is represented by a bar code, using a bar code reader 38. Then, a file 82 corresponding to the read printing plate identification number is read out from the database 81 (step C30), and it is decided from the use situation up to the present time recorded in the file 82 whether regeneration of the printing plate 1 is permitted or inhibited (step C40). If it is discriminated that regeneration of the printing plate 1 is inhibited, then this is displayed on a display unit 80a (step C70). On the other hand, if it is decided that regeneration of the printing plate 1 is permitted, then regeneration of the plate face of the printing plate 1 is performed, and the printing plate identification number temporarily stored in the memory 83 is written on the plate face together with a new pattern (step C50). Further, data of the substance (the number of prints and so forth) of the job in the present cycle, the number of times of regeneration and so forth are recorded into the file 82 to update the file 82 (step C60).

According to such a method as described above, since a printing plate identification number is newly written on the plate face of a printing plate 1 every time regeneration is performed, reading of the printing plate identification number is permitted regardless of over writing of a pattern. Further, since a pattern writing apparatus can be utilized to write the printing plate identification number, the necessity for an equipment for exclusive use for the number application is eliminated. In other words, according to the present method, the functions of the printing plate 1 can be utilized effectively.

(F) Others

While the five embodiments (FIGS. 1 to 16) of the present invention relating to a printing apparatus are described above, the present invention is not limited to the embodiments described above, but can be carried out in various modified forms without departing from the sprit and the scope of the present invention.

For example, the carry-in position and the carry-out position for a carrier in the first and second embodiments are a mere example, and there is no limitation to the positions of them. In the case of the plate making apparatus of the first embodiment, the carry-in and carry-out stations may be positioned at an uppermost portion of the circle. Further, the carry-in station and the carry-out station may be provided separately from each other. For example, the carry-in station may be positioned at an uppermost portion while the carry-out station is positioned at a lower most portion, or they may be positioned conversely. In the case of the plate making apparatus of the second embodiment, the carry-in station is formed as a carry-in and carry-out station which serves also as a carry-out station whereas a carrier for which the plate making process is completed is turned back and fed along the line.

Further, while, in the first and second embodiments, the chuck apparatus are provided on the transport apparatus, the transport apparatus may be formed as an apparatus only for transporting carriers while the chuck apparatus are installed in the individual processing stations. In this instance, when a carrier is transported to a processing station by the transport apparatus, then the carrier is grasped from the opposite sides thereof and centered with a predetermined reference axis by the chuck apparatus provided at the processing station. Where the supporting of a carrier at each processing station is gripping from the opposite sides by chuck apparatus in this manner, the carrier can be carried in and out in a direction perpendicular to the reference axis, that is, in the transport direction by the transport apparatus to and from the processing station. Consequently, transfer of a carrier between the transport apparatus and each processing station can be performed readily, and the transport efficiency of carriers between processing stations is enhanced. Further, when compared with the first and second embodiments, the structure of the feeding apparatus can be simplified.

(G) First Embodiment of the Clean Air Supplying Apparatus

Now, more detailed embodiments relating to the clean air supplying apparatus described hereinabove are described.

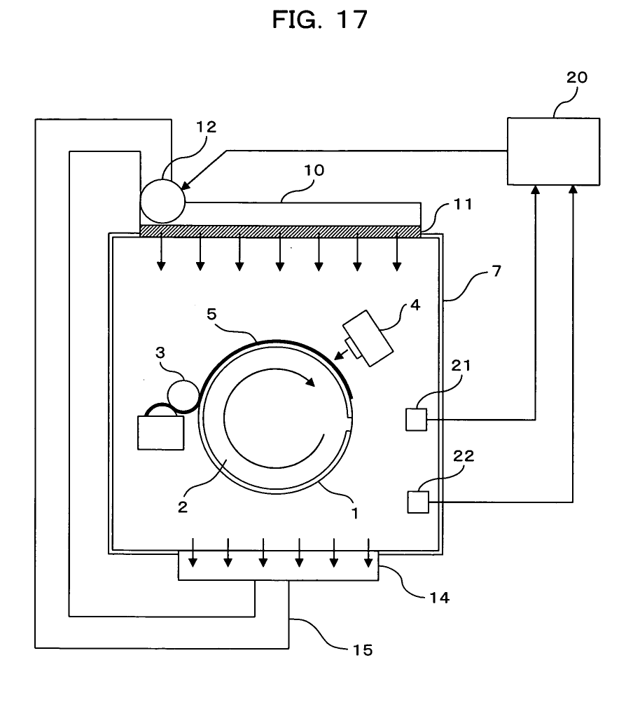

FIG. 17 is a schematic view showing a configuration of a first embodiment of the clean air supplying apparatus. Naturally, also the plate making apparatus of the present embodiment is formed as a so-called extra-machine plate making apparatus which is installed separately from a printing machine.

As shown in FIG. 17, a printing plate 1 of an object of plate making is attached to an outer circumferential face of a support drum (carrier) 102. Here, an applying apparatus 31 and a drying apparatus 32 are disposed in a circumferential direction around the support drum 102. The printing plate 1 successively passes the processing apparatus by rotation of the support drum 102, and first, picture material in the form of liquid is applied to the plate surface by the applying apparatus 31. The picture material applied forms an coating film 5 on the plate surface, and the coating film 5 is heated and dried by heat provided from the next drying apparatus 32 and secured to the plate surface.

In the present plate making apparatus, the support drum 102 and the processing apparatus around the support drum 102 such as the applying apparatus 31 and the drying apparatus 32 are all accommodated in a chamber 107 and isolated from the outside of the chamber 107. A clean air supplying apparatus 110 is installed on a wall face of the chamber 107 on the side on which the applying apparatus 31 and the drying apparatus 32 are disposed as viewed from the support drum 102. The clean air supplying apparatus 110 includes a fan 112 and a filter 111, and air blasted by the fan 112 is passed through the filter 111 to remove dust from the air. Consequently, the air (clean air) from which dust has been removed and which has high cleanliness is supplied into the chamber 7. The clean air is blasted toward the surface of the printing plate 1, particularly toward a region of the surface of the printing plate 1 to which picture material has been applied by the applying apparatus 31 until the coating film 5 of the applied picture material is dried by the drying apparatus 32. Since invasion of dust from the outside can be prevented by the chamber 107 and clean air is blasted in this manner, dust in the air cannot reach the plate surface and adhering of dust to the coating film 5 on the plate surface is prevented.

While the cleanliness of the clean air supplied from the clean air supplying apparatus 110 depends upon the dust removing capacity of the filter 111, clean air of a cleanliness higher than the class 1,000 according to the FED standards (FED-STD-209E) and higher than the class 6 according to the ISO standards (ISO14644-1: 1999) is supplied. Where clean air having such a high cleanliness is supplied, the inside of the chamber 107 can be made a clean room of a high cleanliness, and plate making of a printing plate free from a defect can be achieved.

An exhaust apparatus 114 for compulsorily exhausting the air in the chamber 107 to the outside is installed on a wall face of the chamber 107 opposing to a wall face on which the clean air supplying apparatus 110 is installed. Although dust is always produced in the chamber 107 by operation of the machine, where the air is compulsorily exhausted by the exhaust apparatus 114 in this manner, the air in the chamber 107 can be always ventilated into clean air and adhering of dust to the coating film 5 can be prevented with a higher degree of certainty. It is to be noted that the air volume of exhaust air of the exhaust apparatus 114 is adjusted so that the pressure in the chamber 107 may always be a positive pressure (preferably higher by more than 1 Pa, more preferably higher by more than 10 Pa) with respect to the external pressure. Where the internal pressure of the chamber 107 is kept to a positive pressure, invasion of dust into the chamber 107 from the outside can be prevented further effectively.

An exhaust port of the exhaust apparatus 114 and an intake port of the clean air supplying apparatus 110 are connected to each other by a picture portion forming apparatus 115. Air exhausted to the outside of the chamber 7 from the exhaust apparatus 114 is sucked by the fan 112 of the clean air supplying apparatus 110 through the picture portion forming apparatus 115 and is supplied as clean air again into the chamber 107 after purification by the filter 111. According to such an air circulation system as just described, since air in the chamber 107 is not exhausted to the outside, the working environment therearound can be maintained good.

The clean air supplying apparatus 110 includes a control apparatus 120 for controlling the speed of rotation of the fan 112 serving as a blast source. The control apparatus 120 controls driving force of a driving motor (not shown) for driving the fan 112 thereby to control the speed of rotation of the fan 112. While the control apparatus 120 can perform constant speed operation of maintaining the speed of rotation of the fan 112 at a fixed speed, it can perform also feedback controls based on measurement values of two sensors (measuring instruments) 121 and 122 provided in the chamber 107.

The sensor 121 is a particle sensor for measuring the number of suspended particles in the air, that is, the number of dust elements, and the cleanliness in the chamber 107 can be measured from a measurement value of the particle sensor 121. Since the number of dust elements in the air can be reduced by increasing the air volume of the clean air, the control apparatus 120 controls the speed of rotation of the fan 112 based on the measurement value of the particle sensor 121 to control the air volume of the clean air so that the inside of the chamber 107 may maintain a predetermined cleanliness. Although the number of dust elements in the air increases when the machine in the chamber 107 operates or the chamber 107 is opened as upon exchange of the printing plate 1, where such control as described is performed, the cleanliness in the chamber 107 can be recovered rapidly to a predetermined set value.

The other sensor 122 is a pressure sensor for measuring a difference in pressure between the inside and the outside of the chamber 107. Since the filter 111 of the clean air supplying apparatus 110 gradually suffers from clogging as the use thereof continues, even if the speed of rotation of the fan 112 is fixed, the air volume decreases due to the clogging of the filter 111. Then, when the air volume of the clean air supplied into the chamber 107 decreases, the pressure in the chamber 107 drops and the pressure difference from that of the outside of the chamber 107 decreases. Therefore, the control apparatus 120 corrects the speed of rotation of the fan 112 based on the measurement value of the pressure sensor 122 so that a desired air volume may be obtained even where the clogging of the filter 111 progresses.

It is to be noted that, as the measuring method of a decrease of the air volume caused by clogging of the filter 111, not only a method of measuring the pressure difference between the inside and the out side of the chamber 107 but also another method of measuring the wind speed of the clean air jetted from the clean air supplying apparatus 110 are available. If the filter 111 is clogged, then since also the wind speed of the clean air drops, where the wind speed is measured by means of a wind speed meter and the speed of rotation of the fan 112 is corrected based on the measurement value of the wind speed, a desired air volume can be obtained regardless of the clogging of the filter 111. This method can be applied also to a plate making apparatus described below which does not include a chamber.

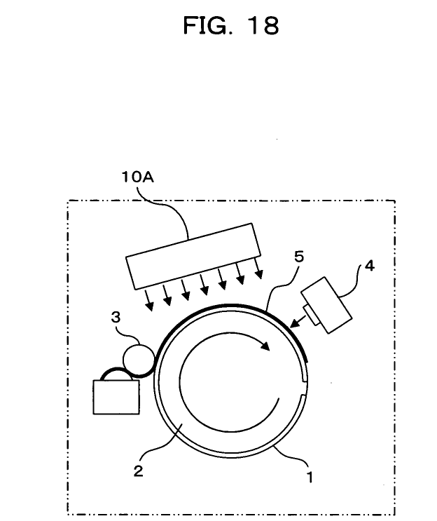

FIG. 18 is a schematic view showing a modification to the clean air supplying apparatus described above. In FIG. 18, like elements to those of FIG. 17 are denoted by like reference numerals. While, in the configuration shown in FIG. 17, a printing plate 1 is isolated by the chamber 107 and clean air is supplied into the chamber 107, according to the configuration shown in FIG. 18, a clean air supplying apparatus 110A is disposed in the proximity of the plate surface of a printing plate 1 without providing a chamber. While the clean air supplying apparatus 110A may have a structure similar to that of the clean air supplying apparatus 110 of FIG. 17, it is disposed such that it can blast clean air toward a region of the printing plate 1 to which picture material has been applied by the applying apparatus 31 at least until the coating film 5 of the applied picture material is dried by the drying apparatus 32. Also with the plate making apparatus having such a configuration as just described, since dust in the air cannot reach the plate surface due to supply of clean air to the surface of the printing plate 1, adhering of dust to the coating film 5 on the plate surface can be prevented.

It is to be noted that, in this instance, the wind speed of the clean air to be supplied from the clean air supplying apparatus 110A is set so that the speed of the wind colliding with the plate surface may remain within the range from 0.1 to 3 m/s in order that adhering of dust to the plate surface can be prevented without disturbing the coating film 5 before it is dried. Further, the area of a blast nozzle for clean air of the clean air supplying apparatus 110A is set so as to assure an area of 50% or more of the picture material application region of the plate surface in order that clean air may be supplied uniformly over the overall application region.

On the other hand, in the case of a plate making apparatus which includes the chamber 107 shown in FIG. 17, since invasion of dust from the outside is prevented, the colliding wind speed within the fixed range required by the structure shown in FIG. 18 is not necessarily required, and there is no restriction to the area of the clean air blast nozzle as well. Further, with the structure shown in FIG. 17, since clean air can be supplied efficiently to the application face, the fan 112 of the clean air supplying apparatus 110 can be miniaturized when compared with the structure shown in FIG. 18. Further, the structure shown in FIG. 17 has an advantage that a high dust removing effect can be achieved also where an obstacle such as a processing apparatus is provided in the space surrounding the application face and a uniform flow speed cannot be obtained.

(H) Second Embodiment of the Clean Air Supplying Apparatus

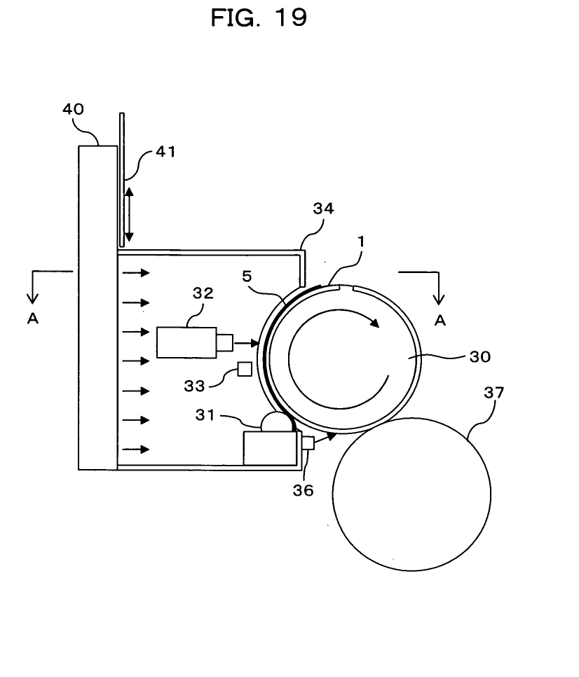

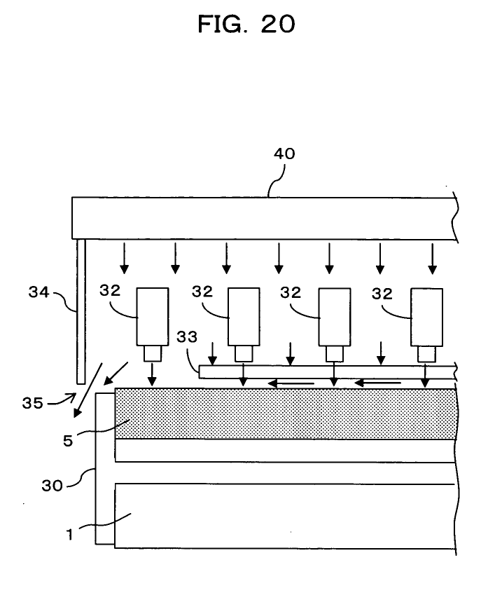

FIGS. 19 and 20 are schematic views showing a configuration of a second embodiment of the clean air supplying apparatus.

As shown in FIGS. 19 and 20, a printing plate 1 of an object of plate making is attached to an outer circumferential face of a printing cylinder (carrier) 130. Also here, processing apparatus such as an applying apparatus 131 and drying apparatus 132 are disposed in a circumferential direction around the printing cylinder 130 in accordance with the order of a plate making procedure from the exit side of a nip between the printing cylinder 130 and a blanket drum 137. A printing plate 1 undergoes plate making by the processing apparatus described above in a state wherein it is attached to the printing cylinder 130, and is used as it is for printing after the plate making.

A clean air supplying apparatus 140 is installed in an opposing relationship to the printing cylinder 130 with the applying apparatus 131 and the drying apparatus 132 interposed therebetween. The clean air supplying apparatus 140 has a structure same as that of the embodiment shown in FIG. 17, and detailed description of the same is omitted. Part of the outer circumferential face of the printing cylinder 130 and the clean air supplying apparatus 140 form wall faces of a chamber 134 opposing to each other, and the applying apparatus 131 and the drying apparatus 132 are accommodated in the chamber 134. A series of processes after picture material is applied to the surface of a printing plate 1 by the applying apparatus 131 until the coating film 5 of the applied picture material is dried by the drying apparatus 132 are performed within the space isolated from the outside by the chamber 134.

An opening 135 is provided as shown in FIG. 20 between a side wall of the chamber 134 and an end portion of the printing cylinder 130. Air in the chamber 134 is discharged to the outside through the opening 135 together with dust produced by operation of the machine and so forth in the chamber 134 and is ventilated with clean air supplied from the clean air supplying apparatus 140. Further, an exhaust nozzle 133 extending in an axial direction of the printing cylinder 130 is provided in the proximity of the surface of the printing cylinder 130 in the chamber 134. The exhaust nozzle 133 is effective not only to exhaust the air in the chamber 134 to the outside but also to control the flow of air in the proximity of the surface of the printing cylinder 130 to form a laminar flow in the proximity of the surface of the printing cylinder 130 thereby to prevent dust from reaching the coating film 5 on the plate surface.

According to the present plate making apparatus having such a configuration as described above, invasion of dust from the outside into the space within which a series of processes after picture material is applied to the surface of the printing plate 1 until the picture material is dried are performed can be prevented by the chamber 134 and clean air is blasted toward the surface of the printing plate 1 from the clean air supplying apparatus 140, dust in the air cannot leach the plate surface, and adhering of dust to the coating film 5 on the plate surface is prevented. Accordingly, while a great amount of dust such as paper powder is produced in the inside of the printing machine when the printing machine operates for printing, according to the present plate making apparatus, a printing plate which does not have a defect also on the printing machine can be produced.

Further, an air knife 136 is provided at the entrance at which the surface of the printing cylinder 130 advances into the chamber 134 as a result of rotation of the printing cylinder 130. The air knife 136 is an apparatus for injecting compressed air pressurized by a compressor and filtered by a filter, and the nozzle thereof is directed toward the surface of the printing cylinder 130. Compressed air injected from the air knife 136 serves as a removing apparatus for blowing off and removing foreign articles such as dust adhering to the surface of the printing plate 1, and this makes it possible to apply picture material after the plate surface is placed into a clean state in advance. Further, since the injection direction of air of the air knife 136 is set to the upstream side in the direction of rotation of the printing cylinder 130, foreign articles blown off are not admitted into the chamber 134 at all.

It is to be noted that the air volume of the clean air supplying apparatus 140 can be controlled through the speed of rotation of a fan (not shown) similarly as in the embodiment (FIG. 17) described hereinabove. The air volume of the clean air supplying apparatus 140 can be controlled also through opening/closing of a shutter 141 provided in front of the nozzle. Accordingly, also it is possible to measure the cleanliness in the inside of the chamber 134 and control the speed of rotation of the fan based on the measurement value of the cleanliness as described hereinabove in the description of the embodiment or also it is possible to control the opening/closing degree of the shutter 141 based on the measurement value. Further, the opening/closing degree of the shutter 141 may be adjusted in accordance with a target air volume while a decreasing amount of the actual air volume with respect to the target air volume caused by clogging of a filter (not shown) is corrected through adjustment of the speed of rotation of the fan.

(I) Others

While two embodiments (FIGS. 17 to 20) of the clean air supplying apparatus are described, the clean air supplying apparatus according to the present invention is not limited to the embodiments described above, but the present invention can be carried out in various modified forms without departing from the spirit and the scope of the present invention. For example, also the plate making apparatus of the first embodiment may include a removing apparatus for removing foreign articles adhering to the surface of a printing plate as in the second embodiment. While, in the second embodiment, an air knife is used as the removing apparatus, also it is possible to suck foreign articles by means of a suction apparatus like a vacuum cleaner, to use a roller having an adhesive surface so that foreign articles may be adhered to the roller or to wipe off foreign articles by means of a wiper.

Further, in any of the embodiments described above, it is possible to provide a heating apparatus such as a heater in the clean air supplying apparatus such that clean air is supplied to the surface of a printing plate after it is heated to raise its temperature. Where clean air of a high temperature is supplied to the plate surface in this manner, drying of the application film can be promoted thereby to further reduce the possibility that dust may adhere to the application film before it becomes dry.

Further, while, in the embodiments described above, the present invention is configured as a general plate making apparatus which has only a plate making function, it is otherwise possible to configure the present invention as a plate making apparatus with a regeneration function whose plate making object is a regenerative printing plate which can be used repeatedly through regeneration of the plate surface and which performs both of regeneration and plate making of a regenerative printing plate.

Furthermore, while, in the embodiments described above, the clean air supplying apparatus is incorporated in one unit together with an applying apparatus or a drying apparatus, the plate making apparatus of the present invention can be configured by attaching the clean air supplying apparatus to a room to produce a clean room and dispose a supporting member for supporting a printing plate, an applying apparatus and a drying apparatus in the clean room. Further, the clean air supplying apparatus may be assembled as one unit together with the applying apparatus or the drying apparatus, and further, the unit may be disposed in a clean room.

(J) Embodiments of the Developing Apparatus

A configuration of the development apparatus 34 of the fourth processing station S4 is further described. For example, the development apparatus 34 of the plate making apparatus of FIG. 1 includes a processing liquid supplying apparatus 34S installed therein. The processing liquid supplying apparatus 34S is disposed such that it is positioned on the lower side of a carrier 2, and supplies developer to the plate face of the printing plate 1 from the lower side of the carrier 2 and further supplies fixing agent to develop a pattern written by the laser writing apparatus 33. Also in the present plate making apparatus 10, there is the possibility that, upon development processing, the developer or the fixing agent may leak or drop. However, since the fourth processing station (developing station) S4 in which the development process is being performed is outside the printing machine, the printing plate 1 or print paper is not contaminated by leak or drop of the processing liquid or by mist after the processing. Further, since there is no necessity to take interference with ink rollers or a wetting apparatus or a damping apparatus disposed around the printing cylinder of the printing machine into consideration and the degree of freedom in space design is very high, the processing liquid supplying apparatus 34S can be disposed on the lower side of the carrier 2 as described above. Consequently, the processing liquid can be supplied to the plate face easily and a high development quality can be achieved. Further, since the development processing is performed off-line independently of operation of the printing machine, also during the development processing, the printing machine can perform printing, and the operating ratio of the printing machine is enhanced. Furthermore, since one plate making apparatus 10 can be shared by a plurality of printing machines, the cost can be suppressed low when compared with an alternative case wherein a plate making apparatus is provided for each printing machine.

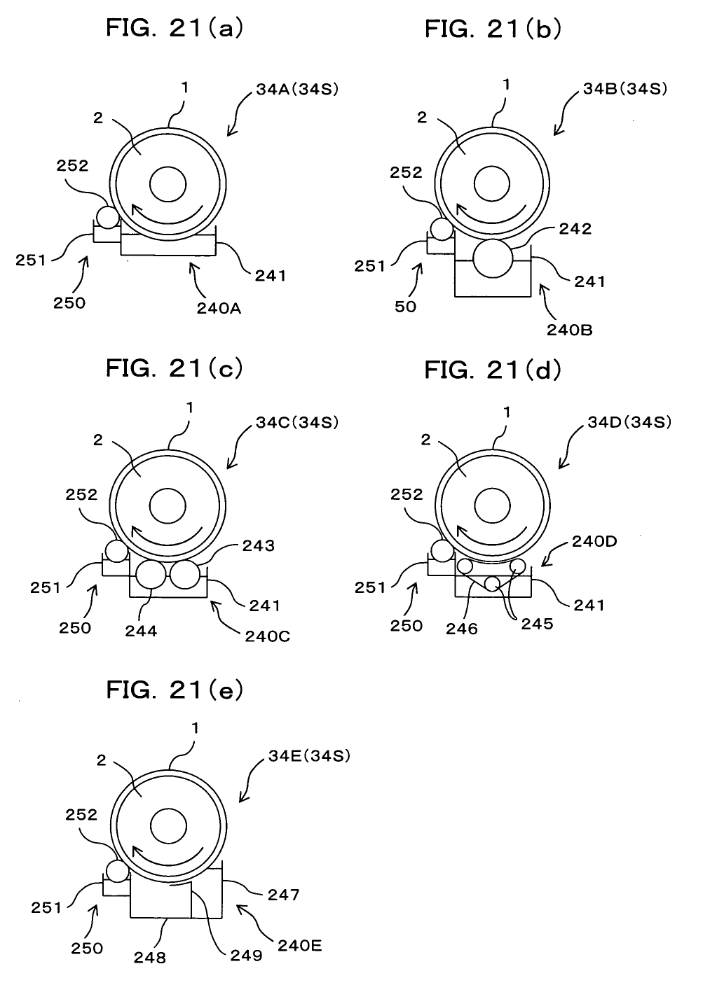

It is to be noted that, in the present invention, the processing liquid supplying apparatus 34S can adopt various configurations as described below. FIGS. 21(a) to 21(e) show various examples of a configuration which the processing liquid supplying apparatus 34S can adopt.

The processing liquid supplying apparatus 34A shown in FIG. 21(a) includes a developing unit 240A for supplying developer and a fixing unit 250 for supplying fixing agent. The fixing unit 250 is disposed on the downstream side of the developing unit 240A in the direction of rotation of the carrier 2. In the developing unit 240A, the plate face of a printing plate 1 is dipped in developer accommodated in a developer tank 241 such that the developer is supplied directly to the plate face of the printing plate 1 through rotation of the carrier 2. Meanwhile, the fixing unit 250 includes a fixing agent tank 251 in which fixing solution is accommodated and a roller 252 having a lower portion dipped in the fixing solution in the fixing agent tank 251. The fixing solution is applied to the plate face of the printing plate 1 through the roller 252.

In the following processing liquid supplying apparatus 34B to 34E shown in FIGS. 21(b) to 21(e), the fixing unit has a configuration same as that of the fixing unit 250 of FIG. 21(a) while only the developing unit is different in configuration. In the processing liquid supplying apparatus 34B shown in FIG. 21(b), a developing unit 240B thereof includes a developer tank 241 and a roller 242 which has a lower portion dipped in developer in the developer tank 241, and the developer is applied to the plate face of the printing plate 1 through the roller 242. A developing unit 240C of the processing liquid supplying apparatus 34C shown in FIG. 21(c) similarly uses a roller. However, two rollers 243 and 244 having a diameter smaller than that of the roller 242 of the developing unit 240B of FIG. 21(b) are disposed in parallel such that the developer is applied to the plate face of the printing plate 1 through the rollers 243 and 244.

The processing liquid supplying apparatus 34D shown in FIG. 21(d) includes a developing unit 240D including a developer tank 241 and a belt 246 guided by a plurality of guide rollers 245. The belt 246 is circulated between the inside of the developer tank 241 and the printing plate 1 while it contacts in face with the plate face of the printing plate 1, and applies the developer, which adheres to the belt 246 when the belt 246 passes the inside of the developer tank 241, to the plate face of the printing plate 1.

The processing liquid supplying apparatus 34E shown in FIG. 21(e) includes a developing unit 240E which in turn includes a developer tank 247 and a catch pan 248. The developing unit 240E dips the plate face of the printing plate 1 directly in the developer similarly to the developing unit 240A of FIG. 21(a). In the present developing unit 240E, also the plate face of the printing plate 1 forms part of a side wall of the developer tank 247. The catch pan 248 is disposed on the downstream side of the developer tank 247 in the direction of rotation of the carrier 2, and a partition wall 249 between the developer tank 247 and the catch pan 248 is worked so as to extend along the outer circumferential face of the carrier 2. As the carrier 2 rotates, the developer adheres to the plate face of the printing plate 1, and when the plate face of the printing plate 1 passes the partition wall 249, surplus developer is recovered by the catch pan 248.

The processing liquid supplying apparatus 34A to 34E described above are mere examples of a configuration which the processing liquid supplying apparatus 34S can adopt at all, and the processing liquid supplying apparatus 34S can adopt various other configurations. For example, while, in the example described above, only one example is shown as regards the configuration of the fixing unit, also the fixing unit can adopt various configurations similar to those of the developing unit. Further, as the method of supplying developer, also other methods can be adopted including a method wherein the developer is sprayed by means of a sprayer, another method wherein a thin film of liquid is supplied from a slit formed by a plurality of plate members (refer to Japanese Patent Laid-Open No. SHO62-238564), and a further method wherein liquid is supplied from a nozzle and stretched using a processing liquid diffuser (refer to Japanese Patent Laid-Open No. SHO56-129212).

Further, as a further additional element, a circulation system may be provided for each of developer and fixing agent. Also it is possible to provide a temperature adjustment apparatus for adjusting the temperature in the developer tank or the fixing agent tank or a temperature adjustment apparatus for adjusting the temperature of the rollers. A mechanism for removing surplus processing liquid from the plate face such as, for example, a blade or a roller may be provided between the developing unit and the fixing unit.

Further, even where the same configuration is employed, it is possible to change the material of the rollers or change the direction of rotation of the rollers. For example, as the material for the rollers, metal, plastics, rubber, sponge, a brush and so forth can be listed, and also a member having a surface worked so as to have a rough face such as an anilox roller may be used. Further, the direction of rotation of the roller may be a forward direction or a reverse direction with respect to the direction of rotation of the carrier 2, and the method for transferring processing liquid from a roller to the printing plate 1 may be any of nip transfer and gap transfer.

What configuration should be employed for the processing liquid supplying apparatus 34S may be determined depending upon properties of a printing material of the printing plate 1. As factors in determination of the configuration of the processing liquid supplying apparatus 34S, a required period of time for contact, a required amount of processing liquid or a circulation amount of liquid, a required degree of a physical stimulus and so forth can be listed. As described hereinabove, the present plate making apparatus can be disposed readily whatever configuration is employed therefor because the plate making apparatus has a very high degree of freedom in space design in terms of arrangement of the development apparatus 34.

It is to be noted that, since the plate making apparatus shown in FIG. 11 has such a configuration as described above, each of carriers 2 carried into the plate making apparatus 50 from the outside is mounted on a pair of chuck apparatus 20 at the carry-in standby station S0 at the front end of the line and is successively transported to the processing stations S1 to S4 as the chain 51 is circulated. Then, when the processes at all of the processing stations S1 to S4 are completed and the carrier 2 is transported to the carry-out standby station S5 at the rear end of the line, the carrier 2 is removed from the chuck apparatus 20 and carried out to the outside from the carry-out standby station S5.

Where the present invention is applied to the plate making apparatus 60 in this manner, since all of the stations S0 to S5 are disposed in a juxtaposed relationship on the line, accessing from the lower side of the apparatus which is advantageous for liquid operation can be performed at all of the processing stations S1 to S4. Consequently, there are advantages that the operability is enhanced and that contamination of the printing plate 1 or the other processing apparatus by drop of liquid from the development apparatus 34 can be prevented.

(K) Others (Development Apparatus)

While two embodiments of the development apparatus of the present invention are described, the development apparatus of the present invention is not limited to the embodiments described above, but the present invention can be carried out in various modified forms without departing from the spirit and the scope of the present invention.

(L) Embodiments of the Cleaning Apparatus (Image Erasing Apparatus)

In the following, an embodiment of a cleaning apparatus 30 (image erasing apparatus) and a cleaning method is described.

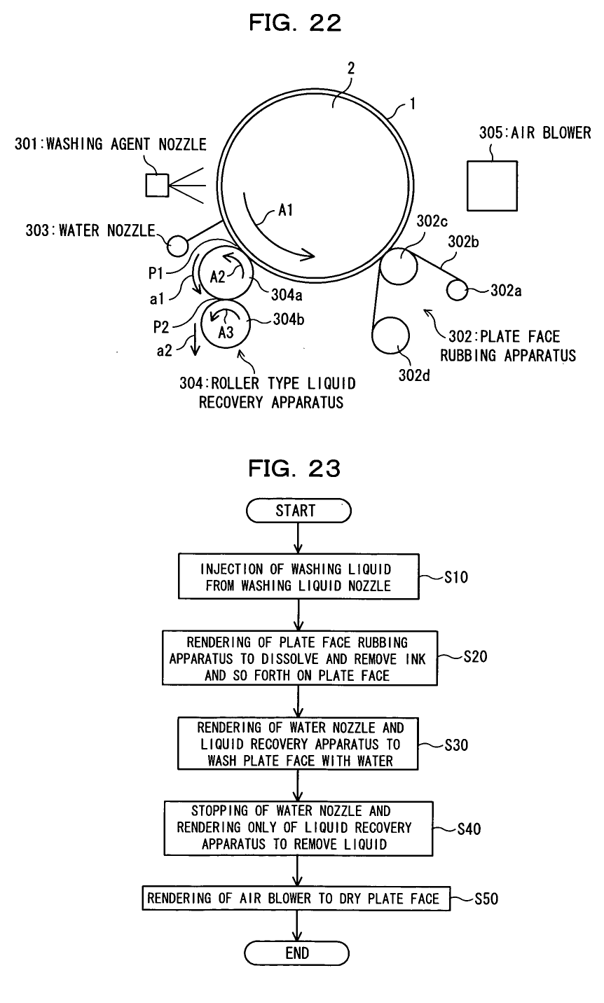

FIGS. 22 and 23 are views showing an image erasing apparatus and method for a regenerative printing plate according to an embodiment of the present invention, and FIG. 22 is a schematic block diagram of the image erasing apparatus for a regenerative printing plate and FIG. 23 is a flow chart illustrating the image erasing method for a regenerative printing plate.

The present image erasing apparatus and method is used for image erasure of a regenerative printing plate which is used repeatedly such that, after an image for planographic printing is written on the surface of a printing plate and used for printing, the image on the surface of the printing plate is erased once, whereafter an image is written on the surface of the printing plate again.

As shown in FIG. 22, a printing plate (regenerative printing plate) 1 is attached to an outer circumferential face of a cylindrical carrier (supporting member) 2 such that it is formed cylindrically and supported by the carrier 2. In the present invention, there is no limitation to the form of the printing plate 1, and it may have any of a plate-like form and a cylindrical form. If the printing plate 1 is a plate-like printing plate, then a tubular member is formed by wrapping the printing plate 1 on the outer circumferential surface of the carrier 2, but if the printing plate 1 is a cylindrical printing plat, then a cylindrical member is formed by fitting the printing plate 1 on the outer circumferential surface of the carrier 2. As the securing method of the printing plate 1 to the carrier 2, for example, a similar method to that used for securing a printing plate to a printing cylinder can be adopted. The carrier 2 has an axial length greater than the transverse width of the printing plate 1 such that it projects somewhat at the opposite end portions thereof from the printing plate 1. It is to be noted that, while the printing plate 1 and the carrier 2 here are formed as separate members, the printing plate 1 may otherwise be formed integrally on the surface of the carrier 2 so that the outer circumferential face itself of the carrier 2 may function as a regenerative printing plate.

The present image erasing apparatus (cleaning apparatus) includes a washing agent nozzle 301 for injecting washing agent (also referred to as liquid washing agent or washing liquid herein) toward the plate face (surface of the printing plate 1), a plate face rubbing apparatus 302 for rubbing the plate face, a water nozzle 303 for injecting water toward the plate face, a liquid recovery apparatus 304 for recovering the water on the plate face, and an air blower 305 [drying apparatus (blasting apparatus) for drying the plate face] for blowing air toward the plate face. The components 301 to 305 are all disposed around the cylindrical printing plate 1.

Although the arrangement of the components 301 to 305 is not limited particularly, preferably the liquid recovery apparatus 304 is disposed in contact with a downwardly directed portion of the plate face below the water nozzle 303 so that water injected to the plate face from the water nozzle 303 may flow down along the plate face and recovered by the liquid recovery apparatus 304.

The components 301 to 305 have a length sufficient to process the printing plate 1 over the overall region in the axial direction and are disposed in parallel to the printing plate 1. The washing agent nozzle 301 and the water nozzle 303 are located in a suitably spaced relationship from the plate face so that they can supply the washing agent and the water just to the plate face, respectively. It is to be noted that, when image erasure is performed by the present apparatus, since the printing plate 1 is rotated as indicated by an arrow mark A1 in FIG. 22, the printing plate 1 can be processed over the overall region in the circumferential direction thereof by the components 301 to 305 disposed at one place of the positions of the printing plate 1 in the circumferential direction.

Further, each of the plate face rubbing apparatus 302 and the liquid recovery apparatus 304 have an essential part thereof held in contact with the plate face. The air blower 305 is installed suitably in a spaced relationship from the plate face by such a distance that drying of the plate face by blown air can be performed efficiently.

The washing agent nozzle 301 or the water nozzle 303 may be of the type which injects washing agent or water in the form of spray or of the type which injects washing agent or water in the form of shower.

The plate face rubbing apparatus 302 here is configured such that a washing cloth 302b wound on a reel 302a is delivered from the reel 302a and placed against the plate face by a fabric pressing pad 302 to wipe the plate face. The washing cloth 302b is taken up on another reel 302d after it wipes the plate face. The plate face rubbing apparatus 302 may be of another type wherein sponge or brush is pressed against the plate face. In this instance, the sponge or the brush may be mounted on the surface of a roller so as to be rotatable or may be of the fixed type wherein it is merely pressed against the plate face. Further, it is possible to spray liquid such as water with a high pressure to the plate face so that a physical stimulus equivalent to rubbing is provided to the plate face.

The liquid recovery apparatus 304 here is of the rotatable roller type and includes a first roller 304a for rotating in the same direction (refer to an arrow mark A2) as that of the printing plate 1 and contacting with the plate face, and a second roller 304b disposed below the first roller 304a for rotating in the same direction (refer to an arrow mark A3) as that of the first roller 304a and contacting with the first roller 304a.

Consequently, the first roller 304a slidably contacts with the plate face such that it moves, at the contacting location with the plate face, in the opposite direction to that of the plate face, and recovers water on the plate face on the upstream side [upstream side in the direction of rotation of the printing plate 1 (the side to which water is supplied from the water nozzle 303)] P1 of the contacting location. The recovered water flows down along the outer circumference of the first roller 304a (refer to an arrow mark a1), passes by one side P2 of the contacting location with the second roller 304b and flows down along the outer circumference of the second roller 304b (refer to an allow mark a2) into a water recovery system not shown below the second roller 304b (refer to an arrow mark a3).

Also to the liquid recovery apparatus 304, various types of liquid recovery apparatus can be applied including a liquid recovery apparatus of the sponge type which uses sponge to recover liquid, another liquid recovery apparatus of the vacuum type which uses a negative pressure to suck water, a further liquid recovery apparatus of the blade type wherein a blade is contacted at a tip end thereof with the plate face to scrape off water and a still further liquid recover apparatus of the fabric type similar to that of the plate face rubbing apparatus 302.

The blown wind by the air blower 305 preferably is warm water for the drying. However, a fixed drying effect is obtained even with wind of a room temperature, and if liquid is recovered sufficiently by the liquid recovery apparatus 304, then the blown air drying by the air blower 305 can be omitted and, in this instance, the air blower 305 is unnecessary. Further, not an air blower for exclusive use but some other air blowing element or some other drying element such as an element for introducing warm wind produced in the proximity of the apparatus or the like may be used.

Since the image erasing apparatus for a regenerative printing plate according to the embodiment of the present invention is configured in such a manner as described above, this apparatus can be used to erase an image of the regenerative printing plate 1 by the image erasing method for a regenerative printing plate according to the present embodiment, for example, as illustrated in FIG. 23.

In particular, washing liquid is first injected from the washing agent nozzle 301 to supply the washing liquid to the plate face (step S10: first step). Consequently, removal object substance [ink, picture material forming material (coating material) and so forth adhering to the plate face] on the plate face is impregnated with the washing liquid and dissolves. It is to be noted that, at this time, the plate face rubbing apparatus 302, water nozzle 303, liquid recovery apparatus 304 and air blower 305 are kept in a stopping state. Then, the plate face rubbing apparatus 302 is rendered operative to rub the plate face to which the washing liquid is supplied to promote the dissolution of the removal object substance such as ink on the plate face to remove the removal object substance (step S20: second step). At this time, while the washing agent nozzle 301, water nozzle 303, liquid recovery apparatus 304 and air blower 305 are basically kept in a stopping state, the washing agent nozzle 301 may be rendered operative simultaneously at an initial stage of operation of the plate face rubbing apparatus 302.

As a result, most of the removal object substance such as ink on the plate face is removed. However, although the amount is small, the removal object substance remains at several places on the plate face or over the overall plate face. Therefore, water is subsequently injected and supplied by the water nozzle 303 toward the plate face on which the dissolved removal object substance remains, and simultaneously the liquid recovery apparatus 304 is rendered operative to recover the water on the plate face including the dissolved removal object substance and the water (step S30: third step). At this time, the washing agent nozzle 301, plate face rubbing apparatus 302 and air blower 305 are kept in a stopping state.

Consequently, almost all of the removal object substance is recovered and removed together with the water. However, if the water remains on the plate face, then such a trouble that the removal object substance contained in the remaining water remains in the form of a spot by a coagulation action of the water by the surface tension occurs. Therefore, subsequently the supply of water is stopped, and only the liquid recovery apparatus 304 is left operative to remove the water on the plate face (step S40: fourth step). At this time, preferably the remaining water film is reduced to such a degree (smaller than approximately 10 μm) that liquid does not drop from the plate face. By the removal of water, such a trouble that the removal object substance contained in the remaining water remains in the form of a spot by a coagulation action of the water by the surface tension can be prevented.

Further, the washing agent nozzle 301, plate face rubbing apparatus 302, water nozzle 303 and liquid recovery apparatus 304 are rendered inoperative while the air blower 305 is rendered operative to promote drying of the plate face (step S50: fifth step).

In this manner, according to the image erasing apparatus and method for a regenerative printing plate according to the present embodiment, an image of a regenerative printing plate can be erased fully with certainty in a short period of processing time. In short, with the present image erasing apparatus, since removal object substance (picture material, ink, various processing agents and so forth) on the plate face can be diluted with normally clean water (preferably distilled water or ion-exchanged water) and recovered in the same operation cycle, the substance on the plate face can be replaced with the clean water in the highest efficiency and picture lines of the regenerative printing plate can be erased with certainty in a reduced period of processing time.

In the present embodiment, since the plate face is dried with blown air (fifth step), the water on the plate face can be removed with a higher degree of certainty, and erasure of an image of a regenerative printing plate can be performed readily with a higher degree of accuracy. However, after the fourth step, the printing plate may be dried by natural drying without executing the fifth step.

Further, a process of such image erasure of a regenerative printing plate as described above can be performed readily and appropriately in an optimum environment by supporting a regenerative printing plate on a tubular supporting member which is removably mounted on the printing machine such that the processes at the steps described above are performed outside the printing machine (that is, by extra-machine plate making) with the tubular supporting member removed from the printing machine. However, the processes at the steps described above may otherwise be performed in a state wherein a regenerative printing plate is placed on the printing machine (that is, by on-machine plate making). In this instance, although environmental setting for the image erasure process becomes difficult, image erasure of a regenerative printing plate can be performed readily in a shorter period of time.

(M) Others (Cleaning Apparatus)

The cleaning apparatus (image erasing apparatus) according to the embodiment described above is an example, and the cleaning (image erasing method) can be carried out widely using not only such a cleaning apparatus as described above but also a cleaning apparatus having functions similar to those of the cleaning apparatus.

Incidentally, the carrier 2 can be used as it is as an interstage sleeve which can be removably mounted on a shaft of the printing machine. As a technique regarding movable mounting in this instance, for example, the technique disclosed in Japanese Patent Laid-Open No. 2001-32240 (Patent Document 1) and so forth are available. However, such a conventional technique as just mentioned has various subjects, and if the interstage sleeve for a printing machine is formed so as to have a light weight and a high strength and besides have a high heat resisting property, then working relating to printing can be enhanced well utilizing the plate making apparatus described above.

In the following, embodiments of an interstage sleeve proposed from such a point of view and applicable also to the plate making apparatus described hereinabove are described.

(N) First Embodiment of the Interstage Sleeve

FIG. 25 is a schematic view showing a configuration of a printing machine (offset printing machine) according to a first embodiment of the present invention. Usually, in a printing machine, a plurality of printing units are disposed in a juxtaposed relationship in a traveling direction of paper in conformity with the number of printing colors. Here, however, only one printing unit 401 is shown for simplified description. A blanket drum 402 and a printing cylinder 403 are disposed in the printing unit 401. It is to be noted that, while a plurality of ink rollers, ink supplying apparatus and so forth are equipped in the inside of the printing unit 401, since they do not have any relationship with the subject matter of the present invention, they are not shown in the figure.

The blanket drum 402 is composed of a center shaft 404 and an interstage sleeve 410 fitted on the center shaft 404, and a blanket 411 is mounted on the surface of the interstage sleeve 410. Similarly, the printing cylinder 403 is composed of a center shaft 405 and an interstage sleeve 420 fitted on the center shaft 405, and a printing plate 21 is mounted on the surface of the interstage sleeve 420. Although the printing plate 421 mounted on the interstage sleeve 420 may be any of a regenerative printing plate on which a pattern is rewritable and an ordinary printing plate (printing plate not of the regenerative type), in the present embodiment, a regenerative printing plate whose pattern can be rewritten is used as the printing plate 421. As a form of mounting of the blanket 411 on the interstage sleeve 410, to form the blanket 411 as a seamless tubular blanket and fit the blanket 411 on an outer circumferential face of the interstage sleeve 410 and to wrap the blanket 411 as an ended plate-like blanket around an outer circumferential face of the interstage sleeve 410 to secure the blanket 411 are listed. However, any of the forms may be used. As a form of installation of the printing plate 421 on the interstage sleeve 420, to form the printing plate 421 integrally with an outer circumferential face of the interstage sleeve 420, to form the printing plate 421 as a seamless tubular printing plate and fit the printing plate 421 on an outer circumferential face of the interstage sleeve 420 and to wrap the printing plate 421 as an ended plate-like printing plate on an outer circumferential face of the interstage sleeve 420 to secure the printing plate 421 are listed. However, any of the forms may be used.

Each of the interstage sleeves 410 and 420 is a cylindrical member of a high rigidity having a sufficient thickness and can be removably mounted on the center shaft 404 or 405 by inserting and removing the center shaft 404 or 405 into and from a hole 410a or 420a provided at a central portion of the interstage sleeve 410 or 420. Rotational driving force is inputted to the center shafts 404 and 405, and the interstage sleeves 410 and 420 rotate integrally with the center shafts 404 and 405, respectively. There is no limitation to the securing method of the interstage sleeves 410 and 420 to the center shafts 404 and 405, respectively. As the securing method, for example, a method wherein the center shafts 404 and 405 is shaped in a tapering condition wherein the outer diameter of the front end sides on which the interstage sleeves 410 and 420 are fitted is a little smaller than the outer diameter of the rear end sides and the interstage sleeves 410 and 420 are pushed to move in an optical direction of the center shafts 404 and 405 on the center shafts 404 and 405 to secure the interstage sleeves 410 and 420 to the center shafts 404 and 405 by a wedge effect of the tapering shape, another method wherein a fastening member such as a bolt is used to secure the interstage sleeves 410 and 420 to the center shafts 404 and 405, respectively, and so forth are listed. However, the securing method is not limited to any of the methods mentioned.

In the printing machine according to the present embodiment, exchange of the blanket 411 or the printing plate 421 is performed together with exchange of the interstage sleeve 410 or 420 in a state wherein the blanket 411 or the printing plate 421 is mounted on the interstage sleeve 410 or 420. Further, a regeneration process of the printing plate 421 involved in rewriting of a pattern is performed on the printing machine not shown or on a regenerative plate making apparatus outside the printing machine while the printing plate 421 remains mounted on the interstage sleeve 420. Where the regenerative plate making apparatus is on the printing machine, a regeneration process of the printing plate 421 is performed in a state wherein the interstage sleeve 420 is mounted on the center shaft 405. On the other hand, where the regenerative plate making apparatus is outside the printing apparatus, the interstage sleeve 420 is removed from the center shaft 405 and set in the regenerative plate making apparatus. Anyway, upon regeneration processing of the printing plate 421 by the regenerative plate making apparatus, the interstage sleeve 420 functions as a support cylinder for supporting the printing plate 421.

For the interstage sleeves 410 and 420, a plurality of different types having an equal inner diameter but having different outer diameters are prepared. This makes it possible to change the circumferential length (that is, cutoff length) of the printing plate 421 or the blanket 411 to cope with a print product of a predetermined length, and the outer diameters of the interstage sleeves 410 and 420 are set in accordance with required cutoff lengths. Further, the distance between the axes of the two center shafts 404 and 405 provided in the printing plate 1 can be variably set in response to the outer diameter of the interstage sleeves 410 and 420 to be mounted thereon as indicated by an arrow mark in FIG. 25. The printing machine according to the present embodiment is constructed as a variable cutoff printing machine whose cutoff length can be varied by exchanging the interstage sleeves 410 and 420 with those of a different outer diameter.

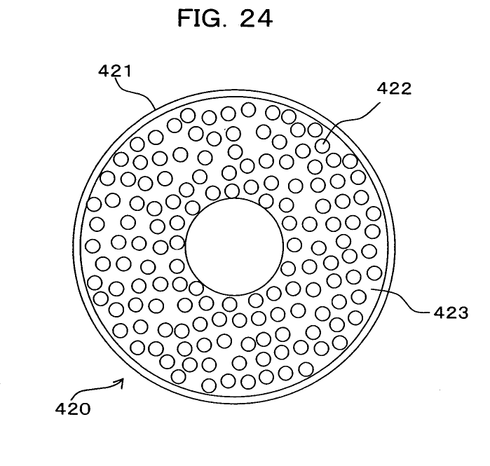

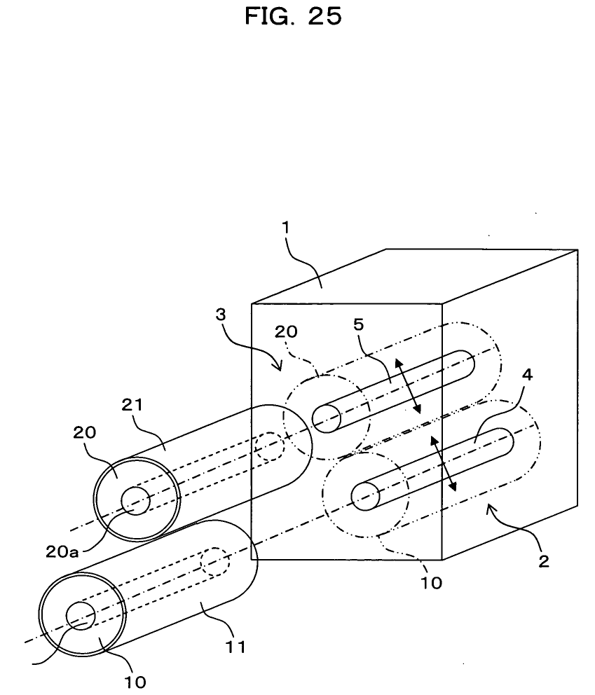

FIG. 24 is a schematic transverse sectional view showing a configuration of the intermediate sleeve 420 for the printing cylinder 403 according to the present embodiment. Though not shown, also the interstage sleeve 410 for the blanket drum 402 has a configuration similar to that of the interstage sleeve 420 for the printing cylinder 403 described below. As shown in FIG. 24, the interstage sleeve 420 is formed as a unitary member from a composite material made of microballoons 422 and resin 423. The microballoons 422 are very small hollow spheres having a diameter of approximately 10 to 200 μm, and a resin material such as epoxy resin, glass such as soda lime silicate glass or ceramics is used as a material for the microballoons 422. For the resin 423, all types of resin such as, for example, epoxy resin, unsaturated polyester resin, polyurethane resin, phenol resin, melamine resin and so forth can be used. Whichever one of the materials should be selected may be determined depending upon required characteristics, a molding method and so forth. Further, as occasion demands (for example, where epoxy resin is used as the resin), curing agent such as diethylenetriamine may be added.

The content of the microballoons 422 in the composite material is set higher than 50%. Where the microballoons 422 are used as a principal material in this manner, the characteristic of the microballoons 422 is dominant in the characteristic of the composite material. Accordingly, since the microballoons 422 have properties that it has a low specific gravity and is superior in strength, where the composite material of the microballoons 422 and the resin 423 is used as a component material as in the interstage sleeve 420 of the present embodiment, a reduced weight and a high compressive resistance of the interstage sleeve 420 itself can be achieved simultaneously. Further, since the microballoons 422 are superior also in heat insulating properties and heat resisting properties, the temperature rise of the interstage sleeve 420 is reduced, and also the heat resisting property is considerably high when compared with that of an alternative case wherein the interstage sleeve 420 is formed otherwise only from resin. Accordingly, also where a regeneration process is performed in a state wherein the printing plate 421 is mounted on the interstage sleeve 420 as described hereinabove, the variation in dimension of the interstage sleeve 420 by heat is very small, and a high degree of printing accuracy can be maintained. Furthermore, where the microballoons 422 are made of an inorganic material such as glass or ceramics, since the chemical stability of the microballoons 422 is high, also enhancement of the chemical resistance can be anticipated with the interstage sleeve 420.

(O) Second Embodiment of the Interstage Sleeve

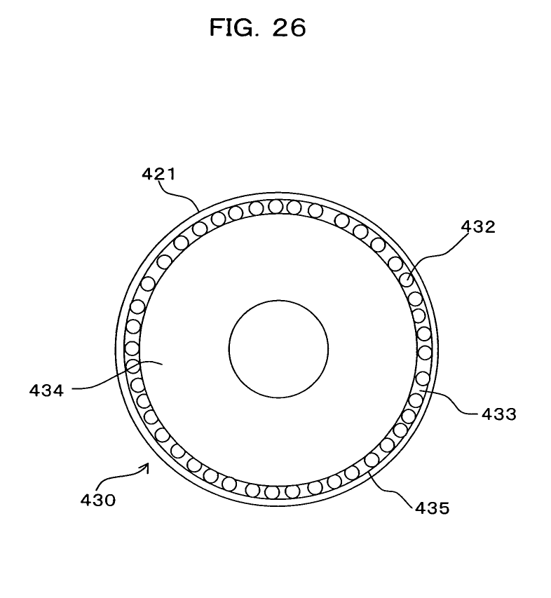

FIG. 26 is a schematic transverse sectional view showing a configuration of the interstage sleeve 430 according to a second embodiment of the present invention. The interstage sleeve 430 of the present embodiment can be used as an interstage sleeve for the blanket drum 402 and also as an interstage sleeve for the printing cylinder 403 in place of the interstage sleeves 410 and 420 of the first embodiment, respectively. It is to be noted that, as hereinafter described, since the interstage sleeve 430 of the present embodiment has a significant advantage where it is used as an interstage sleeve for the printing cylinder 403, the interstage sleeve 430 here is used as an interstage sleeve for the printing cylinder 403.

As shown in FIG. 26, the interstage sleeve 430 includes a surface layer 435 provided on the surface of a base sleeve 434 and formed from a composite material made of microballoons 432 and resin 433. The surface layer 435 has a thickness of 0.1 to 5 mm, and the content of the microballoons 432 in the composite material which forms the surface layer 435 is set higher than 50%, or the coverage factor (projection area ratio) of the microballoons 432 is set higher than 50%. As materials for the microballoons 432 and the resin 433, similar materials to those in the first embodiment can be used. On the other hand, as a material for the base sleeve 434, not only resin but also a material having a light weight and a high strength such as metal, FRP and ceramics can be used.

Since the surface layer 435 includes the microballoons 432 as a principal material, physical and chemical properties of the microballoons 432 appear dominantly. Accordingly, the surface layer 435 has a high heat resisting property, and when a regeneration process is performed in a state wherein a printing plate (regenerative printing plate) 431 is mounted on the interstage sleeve 430, the surface layer 435 functions as a heat insulating barrier for preventing heat supplied to the printing plate 431 in the regeneration process from being transmitted to the base sleeve 434. Accordingly, even if the base sleeve 434 is made of a material which is likely to expand by heat, since transmission of heat is suppressed by the surface layer 435, the dimensional variation of the base sleeve 434 is very small and a high printing accuracy can be maintained. Further, also similar effects to those of the first embodiment such as enhancement of the chemical resistance can be achieved.

It is to be noted that, as a method of forming the surface layer 435, a method of applying resin 433 in which microballoons 432 are mixed and causing the resin 433 to cure, another method of applying a bonding agent to the surface of the base sleeve 434 to adhere the microballoons 432 to the base sleeve 434 and then coating the surface of the base sleeve 434 with a film of resin 433 and so forth are available. In the latter case, the smoothness of the surface of the interstage sleeve 430 can be promoted. Even in the former case, if the surface is further covered with a film of the resin 433, then the smoothness of the surface can be promoted.

The interstage sleeve 430 of the present embodiment is characterized in the surface layer 435, and there is no limitation to the material and the property of the base sleeve 434 (however, preferably a material having a light weight and a high strength is selectively used). Accordingly, the interstage sleeve 430 of the present embodiment can be formed also by an existing interstage sleeve as the base sleeve 434 and forming such a surface layer 435 as in the present invention on the surface of the base sleeve 434.

(P) Third Embodiment of the Interstage Sleeve

FIG. 27 is a schematic transverse sectional view showing a configuration of the interstage sleeve 440 according to a third embodiment of the present invention. The interstage sleeve 440 of the present embodiment can be used not only as an interstage sleeve for the blanket drum 402 but also as an interstage sleeve for the printing cylinder 403 in place of the interstage sleeves 410 and 420 of the first embodiment, respectively, similarly to the interstage sleeve 430 of the second embodiment.

As shown in FIG. 27, the interstage sleeve 440 has a three-layer structure including a base sleeve 444, an intermediate layer 445, and an outer side base sleeve 446. The intermediate layer 445 is a layer formed from a composite material made of microballoons 442 and resin 443, and the content of the microballoons 442 is set higher than 50%. As materials for the microballoons 442 and the resin 443, materials similar to those in the first embodiment can be used. Further, as materials for the base sleeve 444 and the outer side base sleeve 446, a material of a high strength such as metal, FRP, ceramics or the like can be used.

By forming the intermediate layer 445 formed from the composite material made of the microballoons 442 and the resin 443 is formed between the base sleeve 444 and the outer side base sleeve 446 as in the interstage sleeve 440 of the present embodiment, not only similar effects to those of the interstage sleeves 410 and 420 of the first embodiment can be achieved, but also enhancement of the accuracy in dimension can be achieved because the base sleeves 444 and 446 can be used also as an outer framework and an intermediate framework upon molding of the intermediate layer 445.

(Q) Fourth Embodiment of the Interstage Sleeve

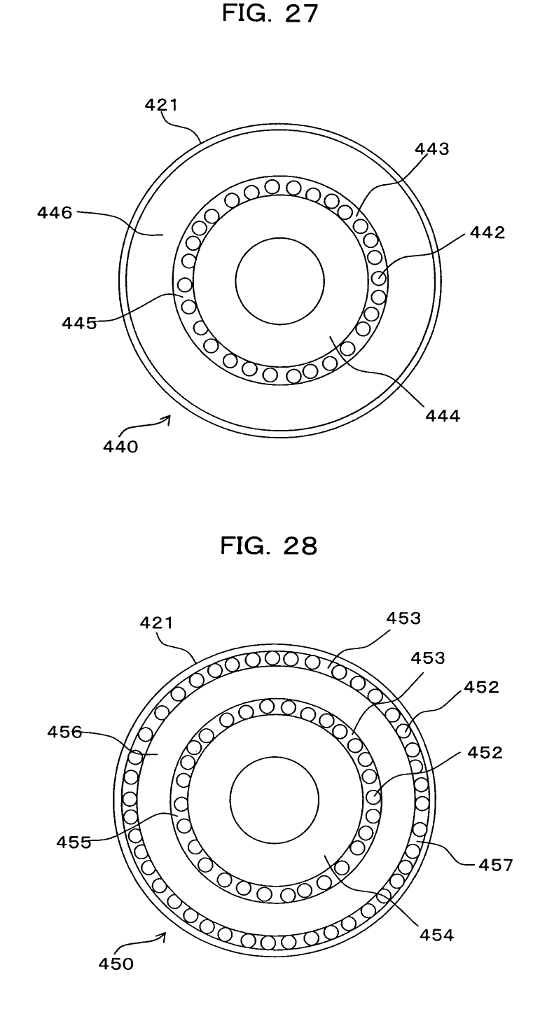

FIG. 28 is a schematic transverse sectional view showing a configuration of an interstage sleeve 450 according to the fourth embodiment of the present invention. Also the interstage sleeve 450 of the present embodiment can be used not only as an interstage sleeve for the blanket drum 402 but also as an interstage sleeve for the printing cylinder 403 in place of the interstage sleeves 410 and 420 of the first embodiment, respectively, similarly to the interstage sleeves 430 and 440 of the second and third embodiments.

As shown in FIG. 28, the interstage sleeve 450 has a four-layer structure including a base sleeve 454, an intermediate layer 455, an outer side base sleeve 456, and a surface layer 457. The present embodiment is a combination of the second embodiment and the third embodiment, and the base sleeve 454, intermediate layer 455 and outer side base sleeve 456 correspond to the base sleeve 444, intermediate layer 445 and outer side base sleeve 446 of the interstage sleeve 440 of the third embodiment, respectively, while the surface layer 457 corresponds to the surface layer 435 of the interstage sleeve 430 of the second embodiment. In particular, the intermediate layer 455 and the surface layer 457 are formed from a composite material made of microballoons 452 and resin 453 while the base sleeve 454 and the outer side base sleeve 456 are formed from metal, FRP, ceramics or the like.

According to the interstage sleeve 450 of the present embodiment, not only similar effects to those of the interstage sleeve 440 of the third embodiment can be achieved, but since the heat insulating surface layer 457 is provided on the surface of the outer side base sleeve 446, even if the outer side base sleeve 446 is made of a material which is likely to expand by heat, transmission of the heat is suppressed by the surface layer 457. Consequently, the dimensional variation of the outer side base sleeve 446 is very small, and a high printing accuracy can be maintained.

(R) Fifth Embodiment of the Interstage Sleeve

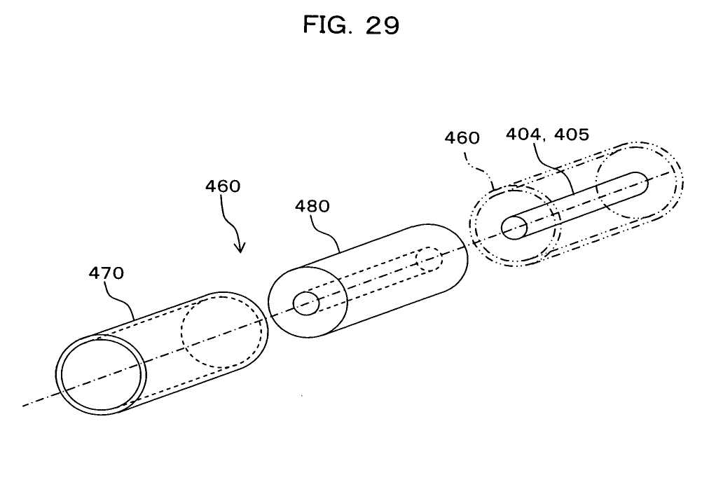

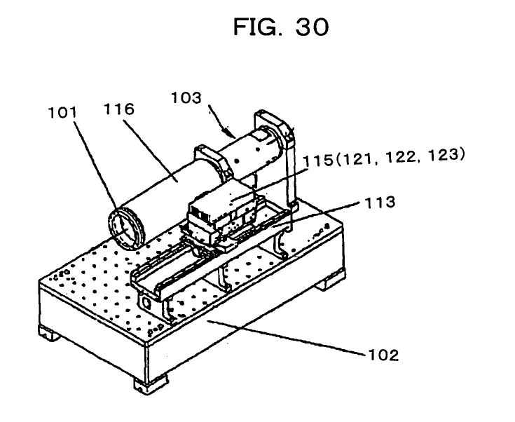

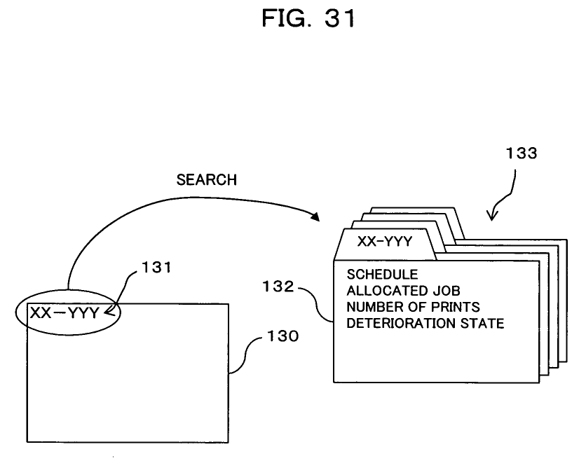

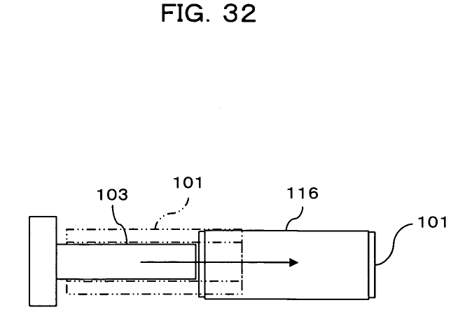

FIG. 29 is a schematic exploded perspective view showing a configuration of an interstage sleeve 460 according to a fifth embodiment of the present invention. Also the interstage sleeve 460 of the present embodiment can be used not only as an interstage sleeve for the blanket drum 402 but also as an interstage sleeve for the printing cylinder 403 in place of the interstage sleeves 410 and 420 of the first embodiment, respectively, similarly to the interstage sleeves 430, 440 and 450 of the second to fourth embodiments.

As shown in FIG. 29, the interstage sleeve 460 has a dual structure including an outer side sleeve 470 and an inner side sleeve 480. The inner side sleeve 480 is attached to the center shaft 404 or 405 of the printing unit while a blanket or a printing plate is mounted on the surface of the outer side sleeve 470. The outer side sleeve 470 and the inner side sleeve 480 are removably mounted on each other, and by slidably moving the outer side sleeve 470 in its axial direction, only the outer side sleeve 470 can be removed from the printing machine while the inner side sleeve 480 is left on the printing machine. As securing means for securing the outer side sleeve 470 to the inner side sleeve 480, for example, a fastening member such as a bolt can be used.

As the structure of the outer side sleeve 470 and the inner side sleeve 480, the structures of the outer side sleeves 410, 420, 430, 440 and 450 according to the first to fourth embodiments can be applied. In particular, each of the outer side sleeve 470 and the inner side sleeve 480 may be a sleeve integrally formed from a composite material made of microballoons and resin. As regards the inner side sleeve 480, a sleeve formed from metal, FRP, ceramics or the like may be used like the base sleeves 434, 444, 446, 454 and 456 according to the second to fourth embodiments.

The interstage sleeve 460 of the present embodiment has a structure particularly suitable as an interstage sleeve for a variable cutoff printing machine. In a variable cutoff printing machine, as a case wherein an interstate sleeve is exchanged, two cases are available including a case wherein the cutoff length is changed and another case wherein a printing plate or a blanket is exchanged. However, the interstage sleeve 460 of such a dual structure as in the present embodiment is used, such a manner of use is possible that, in the former case, the entire interstage sleeve 460 is exchanged, but in the latter case, only the outer side sleeve 470 is exchanged while the inner side sleeve 480 is left. Whereas change of the cutoff length is not performed very frequently, exchange of a printing plate and so forth is performed for every printing. Therefore, although, to the operator, the working burden in exchange of the interstage sleeve 460 involved in exchange of a printing plate or the like is comparatively high, if only it is necessary to exchange the outer side sleeve 470, then the working burden to the operator is reduced significantly.

If the interstage sleeve 460 is used in such a manner as described above, then it is possible to use the outer side sleeve 470 for attachment of a printing plate or a blanket and use the inner side sleeve 480 for adjustment of the thickness. In particular, although, in order to change the cutoff length, a plurality of interstage sleeve 460 having different thicknesses are prepared, the outer side sleeve 470 is formed such that the thickness thereof (outer diameter−inner diameter) is substantially fixed or strength is assured irrespective of the cutoff length while the thickness of the inner side sleeve 480 is adjusted so as to cope with the change of the cutoff length. Where different roles are allocated to the outer side sleeve 470 and the inner side sleeve 480 in this manner, even if the outer diameter increases and the overall weight of the interstage sleeve 460 increases, increase in weight of the outer side sleeve 470 which is exchanged in a high frequency can be suppressed.

(S) Others (Interstage Sleeves)

While several embodiments of the interstage sleeve of the present invention are described, the interstage sleeve of the present invention is not limited to those embodiments, but the present invention can be carried out in various modified forms without departing from the spirit and the scope of the present invention. For example, where the interstage sleeve is formed so as to have such a layer structure as in the second to fourth embodiments, there is no limitation to the number of layers if at least one of the layers is formed from a composite material made of microballoons and resin. Further, where a plurality of layers formed from the composite material are involved, the content of the microballoons may be changed or the material of the microballoons or the resin may be changed depending upon the layer.

### INDUSTRIAL APPLICABILITY

As described above, according to the present invention, plate making (regeneration) of a regenerative printing plate which is used repeatedly can be performed efficiently. Further, since removable mounting of a regenerative printing plate can be performed readily, it is possible to utilize resources efficiently to carry out printing of a high quality.

Accordingly, the present invention can be applied widely to printing machines, and it is considered that the availability thereof is very high.

1. A plate making apparatus, comprising:
a plurality of stations (S0 to S5) arranged in order, the number of said stations being at least equal to the number of steps of a plate making procedure;
a plurality of processing apparatus corresponding one by one to the steps of the plate making procedure and disposed in order of the plate making procedure at said stations (S0 to S5); and
a transport apparatus (11, 51, 61) for successively transporting a plurality of printing plates (1) from one to another one of said stations in order of the plate making procedure.

2. The plate making apparatus as set forth in claim 1, wherein
the printing plates (1) are regenerative printing plates, and the plate making procedure includes a step of regenerating a plate face of each printing plate (1).

3. The plate making apparatus as set forth in claim 2, wherein,
as said processing apparatus, at least a pattern erasing apparatus (30), a picture material applying apparatus (31), a drying apparatus (32) and a pattern writing apparatus (33) are provided.

4. The plate making apparatus as set forth in claim 1, wherein
each of the printing plates (1) is provided on an outer periphery of a cylindrical carrier (2) and is transported integrally with said carrier (2) by said transport apparatus (11, 51, 61).

5. The plate making apparatus as set forth in claim 4, further comprising
a carry-in apparatus (15) including a before-processing stock section in which one or more such carriers (2) before the plate making process are stocked, said carry-in section (15) carrying in one of the carriers from said before-processing stock section to said transport apparatus.

6. The plate making apparatus as set forth in claim 5, wherein
said carry-in apparatus (15) includes, as said before-processing stock section, a pair of inclined rails (13, 16) for supporting the opposite ends of the carrier and further includes one or more stoppers (14, 17) provided on said inclined rails (13, 16) and capable of selecting either one of an on state in which rolling of the carrier (2) is controlled and an off state in which rolling of said carrier (2) is permitted, and carries in the carriers (2) one by one by on/off changeover of said stoppers (14, 17).

7. The plate making apparatus as set forth in claim 5, wherein
said carry-in apparatus (15) includes a decision apparatus for deciding a use situation of each printing plate (1) before the printing plate (1) is carried into said transport apparatus (11, 51, 61) and a selection apparatus for taking out, where it is decided by said decision apparatus that the printing plate is not suitable for regeneration, the carrier (2) which has the rejected printing plate thereon from the carry-in line.

8. The plate making apparatus as set forth in claim 4, further comprising
a carry-out apparatus (15) for carrying out the carriers (2) after the plate making process from said transport apparatus (11, 51, 61), said carry-out apparatus (15) including an after-processing stock section in which one or more such carried out carriers (2) are stocked.

9. The plate making apparatus as set forth in claim 4, wherein
said transport apparatus (11, 51, 61) includes a number of pairs of chuck apparatus (20) for fitting into openings (2a) at the opposite ends of each carrier (2) to grasp the carrier (2) from the opposite sides and centering the carrier (2) with a predetermined reference axis (O2), the number being at least equal to the number of said stations (S0 to S5), each of the carriers (2) being carried while being grasped by said chuck apparatus (20).

10. The plate making apparatus as set forth in claim 9, wherein
the carrier (2) is carried in to a mounting and dismounting position for the carrier (2) by said chuck apparatus (20) from a perpendicular direction to the reference axis (O2), and is carried out in a perpendicular direction to the reference axis (O2).

11. The plate making apparatus as set forth in claim 9, wherein
said stations (S0 to S5) are arranged on a circle centered at a horizontal shaft (O1), and
said transport apparatus (11, 51, 61) revolves said chuck apparatus (20) around the horizontal shaft (O1) to carry the carriers (2) in order from one to another one of said stations.

12. The plate making apparatus as set forth in claim 11, wherein
carry-in and carry-out stations (S0 and S5) for mounting each carrier (2) carried in from the outside on said chuck apparatus (20) and dismounting the carrier (2) after the plate making process therefor from said chuck apparatus (20) to carry out the carrier (2) to the out side are provided at the lowest or highest location of the circle.

13. The plate making apparatus as set forth in claim 11, wherein
a carry-in station (S0) for mounting each carrier (2) carried in from the out side on said chuck apparatus (20) is provided at the lowest or highest location of the circle, and a carry-out station (S5) for dismounting the carrier (2) after the plate making process therefor from said chuck apparatus (20) to carry out the carrier (2) to the outside is provided at a position opposing to said carry-in station (S0) at the lowest or highest location of the circle.

14. The plate making apparatus as set forth in claim 9, wherein
said stations (S0 to S5) are arranged on a line, and
said transport apparatus (11, 51, 61) causes said chuck apparatus (20) to move back and forth along the line to successively carry the carriers (2) from one to another one of said stations.

15. The plate making apparatus as set forth in claim 14, wherein
a carry-in station (S0) for mounting each carrier (2) carried in from the outside on said chuck apparatus (20) is provided at one end of the line, and a carry-out station (S5) for dismounting the carrier (2) after the plate making process therefor from said chuck apparatus (20) to carry out the carrier (2) to the outside is provided at the other end of the line.

16. The plate making apparatus as set forth in claim 14, wherein
carry-in and carry-out stations (S0 and S5) for mounting each carrier (2) carried in from the outside on said chuck apparatus (20) and dismounting the carrier (2) after the plate making process therefor from said chuck apparatus (20) to carry out the carrier (2) to the outside are provided at one end of the line.

17. The plate making apparatus as set forth in claim 11, wherein
said transport apparatus (11, 51, 61) includes a rotary member (11a) supported on said horizontal shaft (O1) and rotatable around said horizontal shaft (O1), and said chuck apparatus (20) is provided on said rotary member (11a).

18. The plate making apparatus as set forth in claim 11, wherein
said transport apparatus (11, 51, 61) includes a guide (53, 63) provided in an arrangement direction of said stations (S0 to S5) and a caterpillar member (52, 62) provided for circulation along said guide (53, 63), and said chuck apparatus (20) is provided on said caterpillar member (52, 62).

19. The plate making apparatus as set forth in claim 4, wherein
a pair of chuck apparatus (20) for fitting into openings (2a) at the opposite ends of each carrier (2) to grasp the carrier (2) from the opposite sides and centering the carrier (2) with a predetermined reference axis (O2) are provided at each of said stations (S0 to S5), and said chuck apparatus (20) mount and dismount each carrier (2) to transfer the carrier (2) between the station (S0 to S5) and said transport apparatus (11, 51, 61).

20. The plate making apparatus as set forth in claim 4, further comprising
an adjustment apparatus for adjusting the position of each of said processing apparatus at each of said stations (S0 to S5) in response to the diameter of the carrier (2).

21. The plate making apparatus as set forth in claim 1, further comprising
a clean air supplying apparatus (19, 110, 110A and 140) for supplying clean air to a periphery of each printing plate (1) at least within a period of time after picture material is applied to the printing plate (1) until the picture material is dried.

22. The plate making apparatus as set forth in claim 21, wherein
the clean air supplied from said clean air supplying apparatus (19, 110, 110A and 140) has a cleanliness of class 1000 or more according to the FED standard.

23. The plate making apparatus as set forth in claim 21 or 22, further comprising
a chamber (107, 134) for isolating, from the outside, a space in which a series of processes in which at least picture material is applied to the surface of each printing plate (1) by said applying apparatus (31, 131) and then the application film of the applied picture material is dried by said drying apparatus (32, 132) is performed,
said clean air supplying apparatus (110, 140) supplying clean air into the inside of said chamber (107, 134).

24. The plate making apparatus as set forth in claim 23, wherein the pressure in said chamber (107, 134) is set higher than that outside of said chamber (107, 134).

25. The plate making apparatus as set forth in claim 23, further comprising
an exhaust apparatus (114) for compulsorily exhausting the air in said chamber (107, 134) to the outside.

26. The plate making apparatus as set forth in claim 25, further comprising
a circulation system for circulating air exhausted by said exhaust apparatus (114) to said clean air supplying apparatus (110) so that the air after purified is used as clean air again.

27. The plate making apparatus as set forth in claim 23, further comprising:
a measuring instrument (121) for measuring the cleanliness in said chamber (107, 134); and
a control apparatus (120) for controlling the air volume of said clean air supplying apparatus (110, 140) so that the measurement value of said measuring instrument (121) may be a predetermined value.

28. The plate making apparatus as set forth in claim 23, further comprising:
a measuring instrument (122) for measuring the difference between the pressure in said chamber (107, 134) and the pressure outside of said chamber (107, 134); and
a control apparatus (120) for controlling the driving force of a blast source of said clean air supplying apparatus (110, 140) so that the measurement value of said measuring instrument (121) may be a predetermined value.

29. The plate making apparatus as set forth in claim 21, further comprising:
a measuring instrument for measuring the wind speed of the clean air supplied from said clean air supplying apparatus (110, 140); and
a control apparatus (120) for controlling the driving force of a blast source of said clean air supplying apparatus (110, 140) so that the measurement value of said measuring instrument may be a predetermined value.

30. The plate making apparatus as set forth in claim 21, further comprising
a removing apparatus for removing foreign substance adhering to the surface of each printing plate before picture material is applied to the printing plate by said picture material applying apparatus (31, 131).

31. The plate making apparatus as set forth in claim 21, further comprising
a heating apparatus for heating the clean air to be supplied from said clean air supplying apparatus (110, 140).

32. The plate making apparatus as set forth in claim 1, further comprising, as the processing apparatus:
a development station (S4) in which a development apparatus (34) for developing a pattern written on the plate face of each printing plate (1);
a supporting member (20) disposed at said development station (S4) for supporting each printing plate (1) in the form of a tube; and
a supplying apparatus (34S, 34A to 34E) disposed at said development station (S4) for supplying processing liquid for development to the plate face of the printing plate (1) supported by said supporting member (20).

33. The plate making apparatus as set forth in claim 32, wherein
the tube is positioned on the upper side of said supplying apparatus (34S, 34A to 34E) at said development station (S4), and said supplying apparatus (34S, 34A to 34E) supplies the processing liquid for development from the lower side of the tube to the plate face of the printing plate (1).

34. The plate making apparatus as set forth in claim 32, wherein
said supplying apparatus (34S, 34A to 34E) includes a processing liquid supplying member configured from one or a plurality of rollers, a spray, or a slit formed from one or a plurality of plate materials.

35. The plate making apparatus as set forth in claim 3, wherein
said pattern erasing apparatus (30) is configured by arranging, around an outer periphery of the regenerative printing plate (1) formed from a cylindrical face:
a washing agent nozzle (301) for injecting washing agent toward the plate face;
a plate face rubbing apparatus (302) for rubbing the plate face;
a water nozzle (303) for injecting water toward the plate face; and
a liquid recovery apparatus (304) for recovering the water on the plate face.

36. The plate making apparatus as set forth in claim 1, further comprising:
a detection apparatus (44) for detecting an abnormal state appearing in the plate making apparatus; and
an outputting apparatus (45) for automatically outputting a signal to the outside when an abnormal state is detected by said detection apparatus (44).

37. The plate making apparatus as set forth in claim 36, wherein
said outputting apparatus (45) automatically outputs an abnormal state signal to a portable terminal of an operator through a telephone line.

38. A plate making apparatus, comprising:
a cylindrical carrier (2) including a printing plate on an outer peripheral face thereof;
a pair of chuck apparatus (20) for fitting in openings at the opposite ends of said carrier (2) to grasp said carrier (2) from the opposite sides and centering said carrier (2) with a predetermined reference axis (O2); and
one or a plurality of processing apparatus disposed in a direction toward said carrier (2) centered by said chuck apparatus (20) for performing a plate making process for the printing plate supported by said carrier (2);
said carrier (2) before processing being carried into a space between the pair of chuck apparatus (20) from a perpendicular direction to said reference axis (02), said carrier (2) after the plate making process being carried out from the space between the pair of chuck apparatus (20) to a perpendicular direction to said reference axis (O2).

39. A management method for a regenerative printing plate which is used in a state wherein the regenerative printing plate is mounted on a cylindrical carrier (2), comprising the steps of:
applying a printing plate identification number to each regenerative printing plate (1) while a carrier identification number is applied to each carrier (2) and producing a file (42) for recording a use situation of each regenerative printing plate (1) for each plate identification number;
recording, when each regenerative printing plate (1) is to be used, the printing plate identification number thereof in a corresponding relationship to the carrier identification number of the carrier (2) on which the regenerative printing plate (1) is mounted into a table (43); and
reading, every time each regenerative printing plate (1) is used, the carrier identification number from the carrier (2) to search the printing plate identification number corresponding to the read carrier identification number from the table (43) and recording and updating the use situation of the regenerative printing plate into the file (42) corresponding to the printing plate identification number.

40. The management method for a regenerative printing plate as set forth in claim 39, wherein
a radio reading type data storage device is attached to each carrier (2) and the carrier identification number is stored in said data storage device.

41. A management method for a regenerative printing plate, comprising the steps of:
writing use situation data on a plate face of a regenerative printing plate (1) together with a pattern;
reading, when the pattern of the regenerative printing plate (1) is to be rewritten, the use situation data of the plate face and temporarily storing the use situation data into a memory (71) before regeneration; and
updating, after the regeneration, the use situation data temporarily stored in the memory together with the new pattern and writing the use situation data on the plate face of the regenerative printing plate (1).

42. A management method for a regenerative printing plate, comprising the steps of:
applying a printing plate identification number to each regenerative printing plate (1) and writing the printing plate identification number on a plate face;
producing a file (82) for recording a use situation of each regenerative printing plate (1) for each plate identification number;
reading, when a pattern of each regenerative printing plate (1) is rewritten, the plate identification number of the plate face and temporarily storing the plate identification number into a memory (83) before regeneration and then recording and updating the use situation of the regenerative printing plate into said file (82) corresponding to the read out printing plate identification number; and
writing, after the regeneration, the printing plate identification number temporarily stored in said memory (83) together with the new pattern on the plate face of the regenerative printing plate (1).

43. An interstage sleeve which is applicable to a cylindrical carrier (2) having a printing plate (1) provided on an outer peripheral face thereof and functions, when mounted on a center shaft provided in a printing machine, as a printing cylinder or a blanket drum of the printing machine, wherein a composite material of a microballoon material and a resin material is used as a configuration material.

44. The interstage sleeve as set forth in claim 43, wherein said interstage sleeve is integrally formed from the composite material.

45. The interstage sleeve as set forth in claim 43, wherein said interstage sleeve is formed from a plurality of layers, and at least one of said layers is formed from the composite material.

46. The interstage sleeve as set forth in claim 45, wherein the layer formed from the composite material forms a surface or a layer in the proximity of the surface.

47. The interstage sleeve as set forth in claim 43, wherein said interstage sleeve has a regenerative printing plate provided on the surface thereof and is mounted on the center shaft such that said interstage sleeve functions as the printing cylinder of the printing machine, and said interstage sleeve functions, when a regeneration process is performed for the printing plate, as means for supporting the printing plate.

48. The interstage sleeve as set forth in claim 43, wherein said interstage sleeve is formed from an outside sleeve and an inside sleeve removable from each other.

49. The interstage sleeve as set forth in claim 48, wherein at least one of said outside sleeve and said inside sleeve is integrally formed from the composite material.

50. The interstage sleeve as set forth in claim 48, wherein at least one of said outside sleeve and said inside sleeve is formed from a plurality of layers, and at least one of the layers is formed from the composite material.

51. The interstage sleeve as set forth in claim 50, wherein the layer formed from the composite material forms the surface of said outside sleeve or a layer in the proximity of the surface of said outside sleeve.

52. The interstage sleeve as set forth in claim 48, wherein said interstage sleeve has a regenerative printing plate provided on the surface thereof and is mounted on the center shaft such that said interstage sleeve function as a printing cylinder of the printing machine, and said outside sleeve functions, when a regeneration process is performed for the printing plate, as means for supporting the printing plate.
